(19) United States
(12) Patent Application Publication
(10) Pub. No.: US 2026/0037595 A1
(43) Pub. Date: Feb. 5, 2026

(54) TENSOR MATRIX MULTIPLICATION WITH QUANTIZATION

(71) Applicant: INTERNATIONAL BUSINESS MACHINES CORPORATION, Armonk, NY (US)

(72) Inventors: Cedric LICHTENAU, Stuttgart (DE); Dan GREINER, San Jose, CA (US); Razvan Peter FIGULI, Remchingen (DE); Simon BUBECK, Kernen im Remstal (DE)

(21) Appl. No.: 18/792,884

(22) Filed: Aug. 2, 2024

(51) Int. Cl. G06F 17/16; G06F 5/01

(52) U.S. Cl. CPC G06F 17/16; G06F 5/01

(57) ABSTRACT

Tensor multiplication with quantization includes obtaining first and second input tensors, obtaining elements of a selected data type based on elements of the first input tensor and elements of the second input tensor, performing matrix multiplication on the elements of the selected data type, the matrix multiplication including performing quantization of intermediate results, and the quantization scaling the intermediate results to provide scaled results of the matrix multiplication, and generating output elements, for an output tensor, using the scaled results. Optional additional quantization is performed on elements of an input tensor to provide at least some of the elements of the selected data type for the matrix multiplication.

### BACKGROUND

One or more aspects relate, in general, to facilitating processing within a computing environment, and in particular, to improving such processing.

In order to enhance processing in computing environments that are data and/or computational-intensive, co-processors are utilized, such as artificial intelligence accelerators (also referred to as neural network processors or neural network accelerators). Such accelerators provide a great deal of compute power used in performing, for instance, involved computations, such as computations on matrices or tensors.

Tensor computations, as an example, are used in complex processing, including deep learning, which is a subset of machine learning. Deep learning or machine learning, an aspect of artificial intelligence, is used in various technologies, including but not limited to, engineering, manufacturing, medical technologies, automotive technologies, computer processing, etc.

To perform artificial intelligence workloads, including tensor computations, a software implementation may be used that executes many instructions on a general-purpose processor or uses a purpose-built hardware implementation. Using many instructions on a general-purpose processor can limit the performance of neural network operations. Further, in programming a purpose-built hardware implementation, the program may have to be modified and recompiled for each hardware generation, increasing complexity and verification costs.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include executing an instruction. Executing the instruction includes obtaining a first input tensor and a second input tensor. Executing the instruction further includes obtaining elements of a selected data type based on elements of the first input tensor and elements of the second input tensor. Executing the instruction additionally includes performing matrix multiplication on the elements of the selected data type. The matrix multiplication includes performing quantization of intermediate results. The quantization scales the intermediate results to provide scaled results of the matrix multiplication. Executing the instruction additionally includes generating output elements, for an output tensor, using the scaled results.

In one or more aspects, a computer system is provided. The computer system includes at least one computing device. The computer system additionally includes a set of one or more computer-readable storage media. The computer system also includes program instructions, collectively stored in the set of one or more computer-readable storage media, for causing the at least one computing device to perform computer operations. The computer operations include executing an instruction. Executing the instruction includes obtaining a first input tensor and a second input tensor. Executing the instruction further includes obtaining elements of a selected data type based on elements of the first input tensor and elements of the second input tensor. Executing the instruction additionally includes performing matrix multiplication on the elements of the selected data type. The matrix multiplication includes performing quantization of intermediate results. The quantization scales the intermediate results to provide scaled results of the matrix multiplication. Executing the instruction additionally includes generating output elements, for an output tensor, using the scaled results.

In one or more aspects, a computer-implemented method is provided. The method includes executing an instruction. Executing the instruction includes obtaining a first input tensor and a second input tensor. Executing the instruction further includes obtaining elements of a selected data type based on elements of the first input tensor and elements of the second input tensor. Executing the instruction additionally includes performing matrix multiplication on the elements of the selected data type. The matrix multiplication includes performing quantization of intermediate results. The quantization scales the intermediate results to provide scaled results of the matrix multiplication. Executing the instruction additionally includes generating output elements, for an output tensor, using the scaled results.

In one or more aspects, a computer system is provided. The computer system includes at least one hardware accelerator to be used in executing an instruction. Executing the instruction includes obtaining a first input tensor and a second input tensor. Executing the instruction also includes checking a value of an indicator and determining, based on the value, that quantization is to be performed. Executing the instruction additionally includes obtaining elements of a selected data type based on elements of the first input tensor and elements of the second input tensor. The selected data type is of a length that is shorter than a length of the elements of the first input tensor or the elements of the second input tensor. Executing the instruction further includes performing matrix multiplication on the elements of the selected data type. The matrix multiplication includes performing quantization of intermediate results, and the quantization scales the intermediate results to provide scaled results of the matrix multiplication. Executing the instruction also includes generating output elements, for an output tensor, using the scaled results. The generated output elements are provided in another data type. The another data type is of a length that is greater than the length of the selected data type.

In one or more aspects, a computer-implemented method is provided. The method includes executing an instruction. Executing the instruction includes obtaining a first input tensor and a second input tensor. Executing the instruction also includes checking a value of an indicator and determining, based on the value, that quantization is to be performed. Executing the instruction additionally includes obtaining elements of a selected data type based on elements of the first input tensor and elements of the second input tensor. The selected data type is of a length that is shorter than a length of the elements of the first input tensor or the elements of the second input tensor. Executing the instruction further includes performing matrix multiplication on the elements of the selected data type. The matrix multiplication includes performing quantization of intermediate results, and the quantization scales the intermediate results to provide scaled results of the matrix multiplication. Executing the instruction also includes generating output elements, for an output tensor, using the scaled results. The generated output elements are provided in another data type. The another data type is of a length that is greater than the length of the selected data type.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts further details of one embodiment of a processor, in accordance with aspects described herein;

FIG. 3A depicts one example of a format of a Neural Network Processing Assist instruction, in accordance with aspects described herein;

FIG. 3B depicts one example of a general register used by the Neural Network Processing Assist instruction, in accordance with aspects described herein;

FIG. 3C depicts one example of another general register used by the Neural Network Processing Assist instruction, in accordance with aspects described herein;

FIG. 3D depicts one example of a parameter block used by a query function of the Neural Network Processing Assist instruction, in accordance with aspects described herein;

FIG. 3E depicts one example of a parameter block used by one or more non-query functions of the Neural Network Processing Assist instruction, in accordance with aspects described herein;

FIG. 3F depicts one example of a tensor descriptor used by the Neural Network Processing Assist instruction, in accordance with aspects described herein;

FIG. 4 depicts an example of a generic 4D-tensor in accordance with aspects described herein;

FIG. 5 depicts an example process for transforming a generic 4D-tensor into a 4D-feature tensor, in accordance with aspects described herein;

FIG. 6 depicts an example of a 4D-feature tensor in accordance with aspects described herein;

FIG. 7 depicts an example process for transforming a generic 4D-tensor into a 4D-kernel tensor, in accordance with aspects described herein;

FIG. 8 depicts an example of a 4D-kernel tensor in accordance with aspects described herein;

FIG. 9 depicts an example process for transforming a generic 4D-tensor into a 4D-weights tensor, in accordance with aspects described herein;

FIG. 10 depicts an example of a 4D-weights tensor in accordance with aspects described herein;

FIG. 11 depicts example quantization processing, in accordance with aspects described herein;

FIG. 12A depicts one example of tensor multiplication code of FIG. 1, in accordance with aspects described herein;

FIG. 12B depicts one example of execute instruction code of the tensor multiplication code of FIG. 12A, in accordance with aspects described herein;

FIG. 12C depicts one example of selected data type elements obtaining code of the execute instruction code of FIG. 12B, in accordance with aspects described herein;

FIG. 12D depicts one example of matrix multiplication code of the execute instruction code of FIG. 12B, in accordance with aspects described herein;

FIG. 13 depicts an example process for tensor multiplication, in accordance with aspects described herein;

FIG. 14A depicts yet another example of a computing environment to incorporate and use one or more aspects described herein; and

FIG. 14B depicts further details of the memory of FIG. 14A, in accordance with one or more aspects described herein.

### DETAILED DESCRIPTION

In accordance with one or more aspects described herein, a capability is provided to facilitate processing within a computing environment, by, for instance, providing tensor matrix multiplication with quantization, which enables tensor matrix multiplication to be performed using elements of data type different from output tensor elements and optionally different from input tensor elements.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction. Executing the instruction includes obtaining a first input tensor and a second input tensor. Executing the instruction further includes obtaining elements of a selected data type based on elements of the first input tensor and elements of the second input tensor. Executing the instruction additionally includes performing matrix multiplication on the elements of the selected data type. The matrix multiplication includes performing quantization of intermediate results. The quantization scales the intermediate results to provide scaled results of the matrix multiplication. Executing the instruction additionally includes generating output elements, for an output tensor, using the scaled results. Performance benefits may be achieved by providing matrix multiplication with quantization of intermediate results, as it enables the use of tensor elements in a form preferred for and/or more advantageous for performing dot product operations (e.g., smaller, more compact), and then quantizing to a different form preferred for output. Some applications do not require aspects of matrix multiplication, such as dot product operations, to be performed with a data resolution of a longer format. Performing aspects of matrix multiplication in, e.g., shorter formats, can reduce memory pressure and data bandwidth, and allow for increased operations per cycle. Seamless format conversion (quantization) as part of instruction execution, as opposed to outside of instruction execution, also increases performance.

Additionally, or alternatively, in one or more embodiments, executing the instruction further includes checking a value of an indicator and determining, based on the value, that the quantization is to be performed. Use of an indicator, for instance a parameter-block-version number as described herein, to identify whether quantization is to be performed have an advantage in that it helps ensure compatible behavior with hardware or architectures that do not support such quantization, for instance legacy architectures. For instance, the value being a selected value (such as zero) can be an expected value of an architecture that does not support quantization. Conversely, an architecture that supports quantization can check the indicator to determine whether quantization is to be performed.

Additionally, or alternatively, in one or more embodiments, the elements of the first input tensor include elements of a first data type, and the elements of the second input tensor include elements of a second data type, the first data type being different than the second data type. The instruction supporting inputs of different data types (through optional quantization thereof) as operands helps avoiding having to perform operations outside of the instruction, for instance operations to convert the input elements ahead of time, which can be expensive in terms of resource consumption.

Additionally, or alternatively, in one or more embodiments, elements of an input tensor, of the first input tensor or the second input tensor, are of a different data type than the selected data type. Additionally, executing the instruction further includes performing quantization of the elements of the input tensor to provide at least some of the elements of the selected data type for the matrix multiplication. Quantization of input tensor elements enables the instruction to take as input different (such as longer format) data types than the selected data type and quantized (for instance scale down) these elements to, e.g., smaller tensor elements for more efficient matrix multiplication operations, for instance dot product operations. Further, quantization as part of the instruction execution helps to increase performance by removing the need to do this in software outside of instruction execution.

Additionally, or alternatively, in one or more embodiments, the quantization of an element of the input tensor includes converting the element of the input tensor using a scale value to scale the element, using an offset value to apply an offset, and using a clip maximum value and a clip minimum value to enforce a maximum value and a minimum value for the element of the selected data type. Such quantization provides versatility in the particular quantization performed, as it provides options for scaling, offsetting, and/or maximum/minimum range enforcement. This avoids software processing to perform these functions separately, which might otherwise involve storage of intermediate results into memory or another location externally accessible to processors and then reloading therefrom. Flexible quantization as part of instruction execution also increases processing speed, reduces use of system resources, and improves performance.

Additionally, or alternatively, in one or more embodiments, executing the instruction further includes checking a value of an indicator and determining, based on the value, that the quantization of the intermediate results and the quantization of the elements of the input tensor are to be performed. In this aspect, both quantizations can be informed based on the particular value of the indicator. Use of an indicator, for instance a parameter-block-version number as described herein, to identify quantization(s) to be performed has an advantage in that it helps ensure compatible behavior with hardware or architectures that do not support such quantization, for instance legacy architectures. For instance, the value being a selected value (such as zero) can be an expected value of an architecture that does not support quantization. Conversely, an architecture that supports quantization can check the indicator to determine whether quantization is to be performed and which quantization(s), such as quantization of the intermediate results and/or quantization of the elements of the input tensor, are to be performed.

Additionally, or alternatively, in one or more embodiments, the generating includes performing one or more operations using a third input tensor and the scaled results to obtain the output elements. By combining multiple operations (matrix multiplication and additional operation(s)) into one function, the number of times a processor is invoked to perform the operations is reduced. Further, storing of intermediate results into memory or another location externally accessible to one or more processors and the reloading therefrom is avoided, which increases processing speed, reduces use of system resources, and improves performance.

Additionally, or alternatively, in one or more embodiments, the selected data type is of a length that is shorter than a length of the elements of the first input tensor or the elements of the second input tensor. This has an advantage in that is provides flexibility in defining a shortened format for aspects of matrix multiplication, and a shortened format may provide a more advantageous format with which to compute, for instance to provide for faster computations. Additionally, or alternatively, in one or more embodiments, the generated output elements are provided in another data type, the another data type being of a length that is greater than the length of the selected data type. This has an advantage in that it enables quantizing, e.g., scaling, results of matrix multiplication to a different (e.g., higher resolution or larger format) which may be more desirable for use in performing other instructions or operations that rely on the results of the instruction execution.

In accordance with one or more aspects, each of the embodiments is separable and optional from one another. Further, embodiments may be combined with one another.

In one or more aspects, a computer system is provided. The computer system includes, for instance, at least one computing device, a set of one or more computer-readable storage media, and program instructions, collectively stored in the set of one or more computer-readable storage media, for causing the at least one computing device to perform computer operations. The computer operations include executing an instruction. Executing the instruction includes obtaining a first input tensor and a second input tensor. Executing the instruction further includes obtaining elements of a selected data type based on elements of the first input tensor and elements of the second input tensor. Executing the instruction additionally includes performing matrix multiplication on the elements of the selected data type. The matrix multiplication includes performing quantization of intermediate results. The quantization scales the intermediate results to provide scaled results of the matrix multiplication. Executing the instruction additionally includes generating output elements, for an output tensor, using the scaled results. Performance benefits may be achieved by providing matrix multiplication with quantization of intermediate results, as it enables the use of tensor elements in a form preferred for and/or more advantageous for performing dot product operations (e.g., smaller, more compact), and then quantizing to a different form preferred for output. Some applications do not require aspects of matrix multiplication, such as dot product operations, to be performed with a data resolution of a longer format. Performing aspects of matrix multiplication in, e.g., shorter formats, can reduce memory pressure and data bandwidth, and allow for increased operations per cycle. Seamless format conversion (quantization) as part of instruction execution, as opposed to outside of instruction execution, also increases performance.

Additionally, or alternatively, in one or more embodiments, executing the instruction further includes checking a value of an indicator and determining, based on the value, that the quantization is to be performed. Use of an indicator, for instance a parameter-block-version number as described herein, to identify whether quantization is to be performed have an advantage in that it helps ensure compatible behavior with hardware or architectures that do not support such quantization, for instance legacy architectures. For instance, the value being a selected value (such as zero) can be an expected value of an architecture that does not support quantization. Conversely, an architecture that supports quantization can check the indicator to determine whether quantization is to be performed.

Additionally, or alternatively, in one or more embodiments, the elements of the first input tensor include elements of a first data type, and the elements of the second input tensor include elements of a second data type, the first data type being different than the second data type. The instruction supporting inputs of different data types (through optional quantization thereof) as operands helps avoiding having to perform operations outside of the instruction, for instance operations to convert the input elements ahead of time, which can be expensive in terms of resource consumption.

Additionally, or alternatively, in one or more embodiments, elements of an input tensor, of the first input tensor or the second input tensor, are of a different data type than the selected data type. Additionally, executing the instruction further includes performing quantization of the elements of the input tensor to provide at least some of the elements of the selected data type for the matrix multiplication. Quantization of input tensor elements enables the instruction to take as input different (such as longer format) data types than the selected data type and quantized (for instance scale down) these elements to, e.g., smaller tensor elements for more efficient matrix multiplication operations, for instance dot product operations. Further, quantization as part of the instruction execution helps to increase performance by removing the need to do this in software outside of instruction execution.

Additionally, or alternatively, in one or more embodiments, executing the instruction further includes checking a value of an indicator and determining, based on the value, that the quantization of the intermediate results and the quantization of the elements of the input tensor are to be performed. In this aspect, both quantizations can be informed based on the particular value of the indicator. Use of an indicator, for instance a parameter-block-version number as described herein, to identify quantization(s) to be performed has an advantage in that it helps ensure compatible behavior with hardware or architectures that do not support such quantization, for instance legacy architectures. For instance, the value being a selected value (such as zero) can be an expected value of an architecture that does not support quantization. Conversely, an architecture that supports quantization can check the indicator to determine whether quantization is to be performed and which quantization(s), such as quantization of the intermediate results and/or quantization of the elements of the input tensor, are to be performed.

Additionally, or alternatively, in one or more embodiments, the generating includes performing one or more operations using a third input tensor and the scaled results to obtain the output elements. By combining multiple operations (matrix multiplication and additional operation(s)) into one function, the number of times a processor is invoked to perform the operations is reduced. Further, storing of intermediate results into memory or another location externally accessible to one or more processors and the reloading therefrom is avoided, which increases processing speed, reduces use of system resources, and improves performance.

Additionally, or alternatively, in one or more embodiments, the selected data type is of a length that is shorter than a length of the elements of the first input tensor or the elements of the second input tensor. Additionally, the generated output elements are provided in another data type, the another data type being of a length that is greater than the length of the selected data type. This has an advantage in that is provides flexibility in defining a shortened format for aspects of matrix multiplication, and a shortened format may provide a more advantageous format with which to compute, for instance to provide for faster computations. It also enables quantizing, e.g., scaling, results of matrix multiplication to a different (e.g., higher resolution or larger format) which may be more desirable for use in performing other instructions or operations that rely on the results of the instruction execution.

In accordance with one or more aspects, each of the embodiments is separable and optional from one another. Further, embodiments may be combined with one another.

In one or more aspects, a computer-implemented method is provided. The computer-implemented method includes, for instance, executing an instruction. Executing the instruction includes obtaining a first input tensor and a second input tensor. Executing the instruction further includes obtaining elements of a selected data type based on elements of the first input tensor and elements of the second input tensor. Executing the instruction additionally includes performing matrix multiplication on the elements of the selected data type. The matrix multiplication includes performing quantization of intermediate results. The quantization scales the intermediate results to provide scaled results of the matrix multiplication. Executing the instruction additionally includes generating output elements, for an output tensor, using the scaled results. Performance benefits may be achieved by providing matrix multiplication with quantization of intermediate results, as it enables the use of tensor elements in a form preferred for and/or more advantageous for performing dot product operations (e.g., smaller, more compact), and then quantizing to a different form preferred for output. Some applications do not require aspects of matrix multiplication, such as dot product operations, to be performed with a data resolution of a longer format. Performing aspects of matrix multiplication in, e.g., shorter formats, can reduce memory pressure and data bandwidth, and allow for increased operations per cycle. Seamless format conversion (quantization) as part of instruction execution, as opposed to outside of instruction execution, also increases performance.

Additionally, or alternatively, in one or more embodiments, executing the instruction further includes checking a value of an indicator and determining, based on the value, that the quantization is to be performed. Use of an indicator, for instance a parameter-block-version number as described herein, to identify whether quantization is to be performed have an advantage in that it helps ensure compatible behavior with hardware or architectures that do not support such quantization, for instance legacy architectures. For instance, the value being a selected value (such as zero) can be an expected value of an architecture that does not support quantization. Conversely, an architecture that supports quantization can check the indicator to determine whether quantization is to be performed.

Additionally, or alternatively, in one or more embodiments, the elements of the first input tensor include elements of a first data type, and the elements of the second input tensor include elements of a second data type, the first data type being different than the second data type. The instruction supporting inputs of different data types (through optional quantization thereof) as operands helps avoiding having to perform operations outside of the instruction, for instance operations to convert the input elements ahead of time, which can be expensive in terms of resource consumption.

Additionally, or alternatively, in one or more embodiments, elements of an input tensor, of the first input tensor or the second input tensor, are of a different data type than the selected data type. Additionally, executing the instruction further includes performing quantization of the elements of the input tensor to provide at least some of the elements of the selected data type for the matrix multiplication. Quantization of input tensor elements enables the instruction to take as input different (such as longer format) data types than the selected data type and quantized (for instance scale down) these elements to, e.g., smaller tensor elements for more efficient matrix multiplication operations, for instance dot product operations. Further, quantization as part of the instruction execution helps to increase performance by removing the need to do this in software outside of instruction execution.

Additionally, or alternatively, in one or more embodiments, executing the instruction further includes checking a value of an indicator and determining, based on the value, that the quantization of the intermediate results and the quantization of the elements of the input tensor are to be performed. In this aspect, both quantizations can be informed based on the particular value of the indicator. Use of an indicator, for instance a parameter-block-version number as described herein, to identify quantization(s) to be performed has an advantage in that it helps ensure compatible behavior with hardware or architectures that do not support such quantization, for instance legacy architectures. For instance, the value being a selected value (such as zero) can be an expected value of an architecture that does not support quantization. Conversely, an architecture that supports quantization can check the indicator to determine whether quantization is to be performed and which quantization(s), such as quantization of the intermediate results and/or quantization of the elements of the input tensor, are to be performed.

Additionally, or alternatively, in one or more embodiments, the generating includes performing one or more operations using a third input tensor and the scaled results to obtain the output elements. By combining multiple operations (matrix multiplication and additional operation(s)) into one function, the number of times a processor is invoked to perform the operations is reduced. Further, storing of intermediate results into memory or another location externally accessible to one or more processors and the reloading therefrom is avoided, which increases processing speed, reduces use of system resources, and improves performance.

Additionally, or alternatively, in one or more embodiments, the selected data type is of a length that is shorter than a length of the elements of the first input tensor or the elements of the second input tensor. Additionally, the generated output elements are provided in another data type, the another data type being of a length that is greater than the length of the selected data type. This has an advantage in that is provides flexibility in defining a shortened format for aspects of matrix multiplication, and a shortened format may provide a more advantageous format with which to compute, for instance to provide for faster computations. It also enables quantizing, e.g., scaling, results of matrix multiplication to a different (e.g., higher resolution or larger format) which may be more desirable for use in performing other instructions or operations that rely on the results of the instruction execution.

In accordance with one or more aspects, each of the embodiments is separable and optional from one another. Further, embodiments may be combined with one another.

In one or more aspects, a computer system is provided. The computer system includes at least one hardware accelerator to be used in executing an instruction. Executing the instruction includes obtaining a first input tensor and a second input tensor. Executing the instruction also includes checking a value of an indicator and determining, based on the value, that quantization is to be performed. Executing the instruction additionally includes obtaining elements of a selected data type based on elements of the first input tensor and elements of the second input tensor. The selected data type is of a length that is shorter than a length of the elements of the first input tensor or the elements of the second input tensor. Executing the instruction further includes performing matrix multiplication on the elements of the selected data type. The matrix multiplication includes performing quantization of intermediate results. The quantization scales the intermediate results to provide scaled results of the matrix multiplication. Executing the instruction also includes generating output elements, for an output tensor, using the scaled results. The generated output elements are provided in another data type, the another data type being of a length that is greater than the length of the selected data type. Performance benefits may be achieved by providing matrix multiplication with quantization of intermediate results, as it enables the use of tensor elements in a form preferred for and/or more advantageous for performing dot product operations (e.g., smaller, more compact), and then quantizing to a different form preferred for output. Some applications do not require aspects of matrix multiplication, such as dot product operations, to be performed with a data resolution of a longer format. Performing aspects of matrix multiplication in, e.g., shorter formats, can reduce memory pressure and data bandwidth, and allow for increased operations per cycle. Seamless format conversion (quantization) as part of instruction execution, as opposed to outside of instruction execution, also increases performance. Additionally, use of an indicator, for instance a parameter-block-version number as described herein, to identify whether quantization is to be performed have an advantage in that it helps ensure compatible behavior with hardware or architectures that do not support such quantization, for instance legacy architectures. For instance, the value being a selected value (such as zero) can be an expected value of an architecture that does not support quantization. Conversely, an architecture that supports quantization can check the indicator to determine whether quantization is to be performed. Further, support for different data lengths has advantages in that it provides flexibility in defining a shortened format for aspects of matrix multiplication, and a shortened format may provide a more advantageous format with which to compute, for instance to provide of faster computations. It also enables quantizing, e.g., scaling, results of matrix multiplication to a different (e.g., higher resolution or larger format) which may be more desirable for use in performing other instructions or operations that rely on the results of the instruction execution.

In one or more aspects, a computer-implemented method is provided. The method includes executing an instruction. Executing the instruction includes obtaining a first input tensor and a second input tensor. Executing the instruction also includes checking a value of an indicator and determining, based on the value, that quantization is to be performed. Executing the instruction additionally includes obtaining elements of a selected data type based on elements of the first input tensor and elements of the second input tensor. The selected data type is of a length that is shorter than a length of the elements of the first input tensor or the elements of the second input tensor. Executing the instruction further includes performing matrix multiplication on the elements of the selected data type. The matrix multiplication includes performing quantization of intermediate results. The quantization scales the intermediate results to provide scaled results of the matrix multiplication. Executing the instruction also includes generating output elements, for an output tensor, using the scaled results. The generated output elements are provided in another data type, the another data type being of a length that is greater than the length of the selected data type. Performance benefits may be achieved by providing matrix multiplication with quantization of intermediate results, as it enables the use of tensor elements in a form preferred for and/or more advantageous for performing dot product operations (e.g., smaller, more compact), and then quantizing to a different form preferred for output. Some applications do not require aspects of matrix multiplication, such as dot product operations, to be performed with a data resolution of a longer format. Performing aspects of matrix multiplication in, e.g., shorter formats, can reduce memory pressure and data bandwidth, and allow for increased operations per cycle. Seamless format conversion (quantization) as part of instruction execution, as opposed to outside of instruction execution, also increases performance. Additionally, use of an indicator, for instance a parameter-block-version number as described herein, to identify whether quantization is to be performed have an advantage in that it helps ensure compatible behavior with hardware or architectures that do not support such quantization, for instance legacy architectures. For instance, the value being a selected value (such as zero) can be an expected value of an architecture that does not support quantization. Conversely, an architecture that supports quantization can check the indicator to determine whether quantization is to be performed. Further, support for different data lengths has advantages in that it provides flexibility in defining a shortened format for aspects of matrix multiplication, and a shortened format may provide a more advantageous format with which to compute, for instance to provide of faster computations. It also enables quantizing, e.g., scaling, results of matrix multiplication to a different (e.g., higher resolution or larger format) which may be more desirable for use in performing other instructions or operations that rely on the results of the instruction execution.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

Further, it is noted that advantages described or set-forth explicitly or implicitly herein may not be present in all embodiments described herein, and are not necessarily required of all embodiments described herein.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as tensor multiplication code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

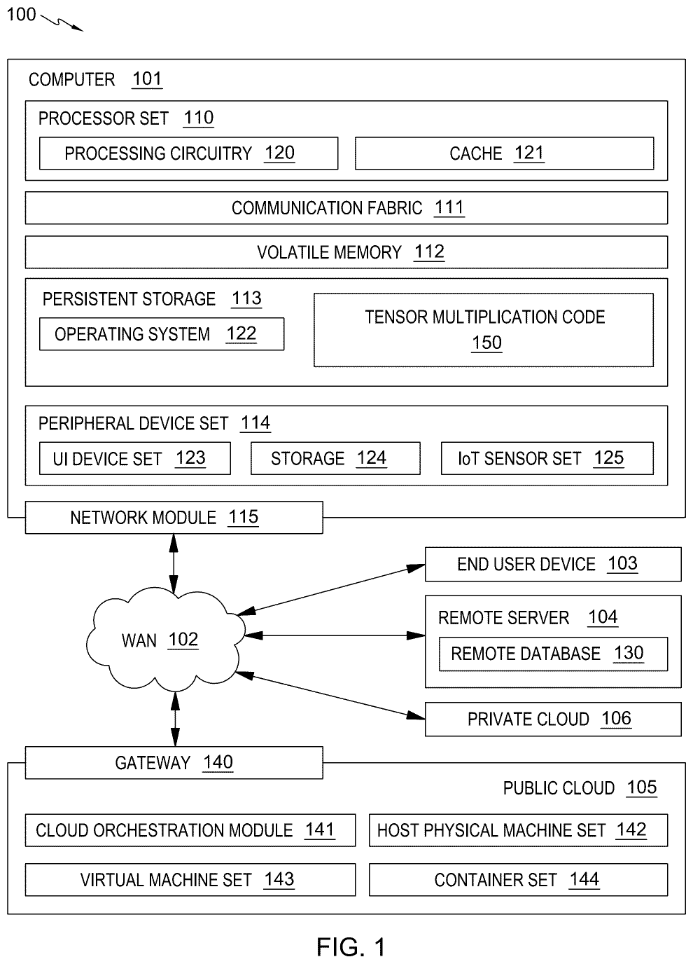

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. In addition, a processor as used herein could be or incorporate a neural network processor. Other variations are possible.

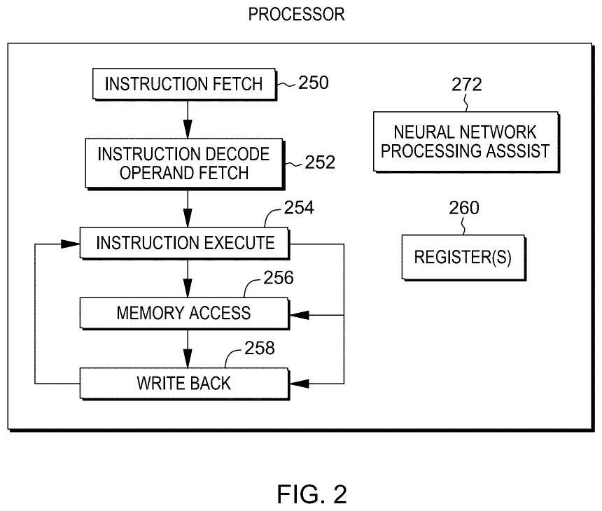

In one example, a processor (e.g., of processor set 110) includes a plurality of functional components (or a subset thereof) used to execute instructions. FIG. 2 depicts further details of one embodiment of a processor, in accordance with aspects described herein. As depicted in FIG. 2, these functional components include, for instance, an instruction fetch component 250 to fetch instructions to be executed; an instruction decode unit 252 to decode the fetched instructions and to obtain operands of the decoded instructions; one or more instruction execute components 254 to execute the decoded instructions; a memory access component 256 to access memory for instruction execution, if necessary; and a write back component 258 to provide the results of the executed instructions. One or more of the components may access and/or use one or more registers 260 in instruction processing. Further, one or more of the components may, in accordance with one or more aspects described herein, include at least a portion of or have access to one or more other components used in performing neural network processing assist processing of, e.g., a Neural Network Processing Assist instruction (or other processing that may use one or more aspects described herein), as described herein. The one or more other components may include, for instance, a neural network processing assist component 272 (and/or one or more other components).

Aspects described herein can be provided as part of architected instruction(s), for instance those of an instruction set architecture. For instance, aspects may be provided as part of, and are described herein in the context of, a Neural Network Processing Assist instruction, although this is for purposes of example only, and not limitation.

A Neural Network Processing Assist instruction is configured to implement multiple functions, which could include a query function and a plurality of non-query functions. The non-query functions include, for instance, functions related to tensor computations. The Neural Network Processing Assist instruction is, for instance, a single instruction (e.g., a single architected hardware machine instruction at the hardware/software interface) that is part of an instruction set architecture (ISA), which is processed (e.g., decoded and/or executed, at least in part) on one or more processors, for example one or more general-purpose processors, one or more special-purpose processors, or a combination of the two. For instance, the instruction is dispatched by a program on a general-purpose processor, which decodes and initiates the instruction. Functions specified by the instruction may be performed by the general-purpose processor and/or a special-purpose processor, such as a co-processor configured for certain functions, that is coupled to or part of the general-purpose processor. Then, the instruction completes on, e.g., the general-purpose processor. In other examples, the instruction is initiated, executed and completed on one or more general-purpose processors or one or more special-purpose processors. An example of a special-purpose processor is a neural network processor.

In one embodiment, the single architected instruction operates, for instance, on main memory and is, for instance, synchronously executed. The main memory may be shared with a special-purpose processor used to execute one or more functions, e.g., one or more non-query functions. The use of shared main memory eliminates a need for costly memory pinning and/or input/output (I/O) operations to communicate with the special-purpose processor. It provides memory coherency, in which caches of the general-purpose processor and special-purpose processor remain coherent. Further, since, in one example, the instruction is executed synchronously, in one example, the processor initiating the instruction provides, during execution of the instruction, information to the special-purpose processor (or another processor) that is executing a function specified by the instruction, but does not perform other work unless there is an interruption of the instruction or the instruction completes.

The Neural Network Processing Assist instruction can implement aspects described herein to provide increased performance compared to previous techniques, such as using many instructions and/or programming a purpose-built processor that may need re-programming for other generations. Executing the Neural Network Processing Assist instruction uses less execution cycles compared to, e.g., a software implementation. Use of the single instruction to perform functions described herein, which could include multiple functions, allows for, e.g., reuse of software over many machine generations with high performance. Each of the functions may be configured as part of the single instruction (e.g., the single architected instruction), reducing use of system resources and complexity, and improving system performance.

Further details relating to executing an instruction, for instance a Neural Network Processing Assist instruction, are now described A Neural Network Processing Assist instruction is obtained by a processor, such as a general-purpose processor and is decoded. The decoded instruction is issued, e.g., on the general-purpose processor. A determination is made as to a function to be performed. In one example, this determination is made by checking a function code field of the instruction, an example of which is described below. The function is then performed.

In one embodiment, performing the function includes determining whether the function is to be performed on a special-purpose processor, such as a neural network processor. For instance, in one example, a query function of the Neural Network Processing Assist instruction is performed on a general-purpose processor and non-query functions are performed on a special-purpose processor. However, other variations are possible. If the function is not to be performed on the special-purpose processor, then in one example, it is performed on the general-purpose processor. However, if the function is to be performed on the special-purpose processor (e.g., it is a non-query function, or in another example, one or more selected functions), then information is provided, e.g., by the general-purpose processor to the special-purpose processor for use in executing the function, such as memory address information relating to tensor data to be used in neural network computations. The special-purpose processor obtains the information and performs the function. After execution of the function is complete, processing returns to the general-purpose processor, which completes the instruction. (In other examples, the instruction may be initiated, executed and completed on one or more general-purpose processors or one or more special-purpose processors. Other variations are possible.)

In some embodiments, the general-purpose and special-purpose processors share memory, such as main memory, providing cache coherency, reducing complexity and improving system performance. Further, in one or more aspects, processing of the instruction by, e.g., the general-purpose processor, includes synchronous execution of the instruction, in which the general-purpose processor, as an example, refrains from performing work other than work related to the instruction, such as providing information, e.g., input data addresses, to the special-purpose processor (or other processor) performing the function. The synchronous execution terminates based, e.g., on completion of the instruction or an interrupt of the instruction.

In some embodiments, the instruction is configured to be interruptible. Thus, in executing the instruction, a determination can be made as to whether a previous execution of the instruction has been interrupted. This is determined, in one example, by checking an indicator, such as, for instance, a continuation flag provided in a parameter block used by the instruction being executed. If the previous execution of the instruction, and thus, the specified function, was interrupted, then, in one example, information stored in a select buffer, such as a continuation state buffer, an example of which is described herein, is used to resume the operation that was interrupted.

Additional details relating to a Neural Network Processing Assist instruction and functions that are supported by the instruction are described herein. In the description herein of the instruction and/or functions of the instruction, specific locations, specific fields and/or specific sizes of the fields are indicated (e.g., specific bytes and/or bits). However, other locations, fields and/or sizes may be provided. Further, although the setting of a bit to a particular value, e.g., one or zero, may be specified, this is only an example. The bit, if set, may be set to a different value, such as the opposite value or to another value, in other examples. Many variations are possible.

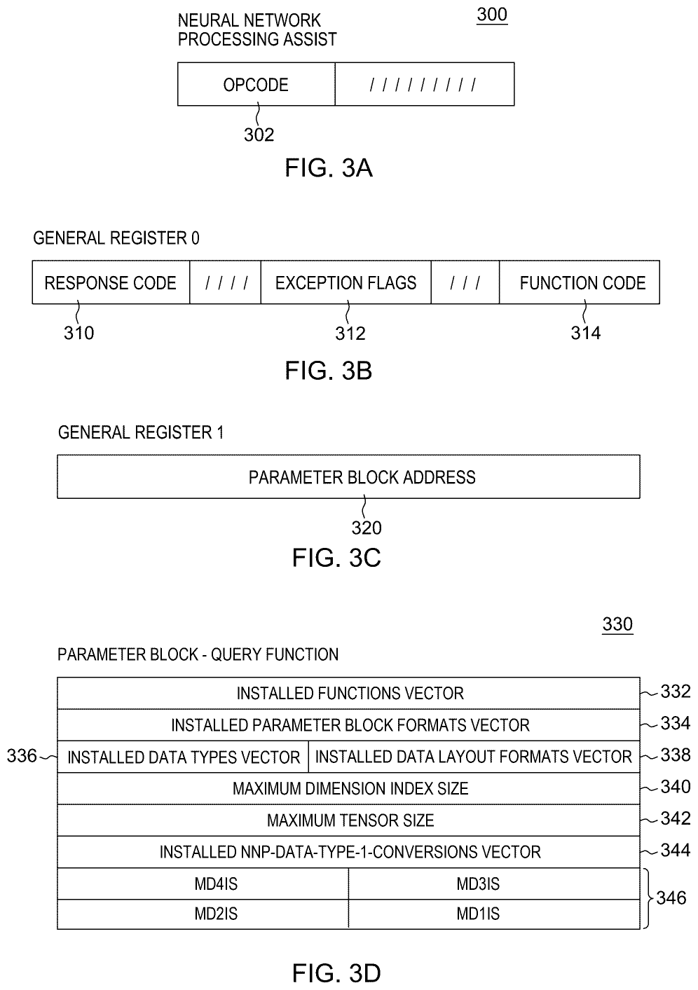

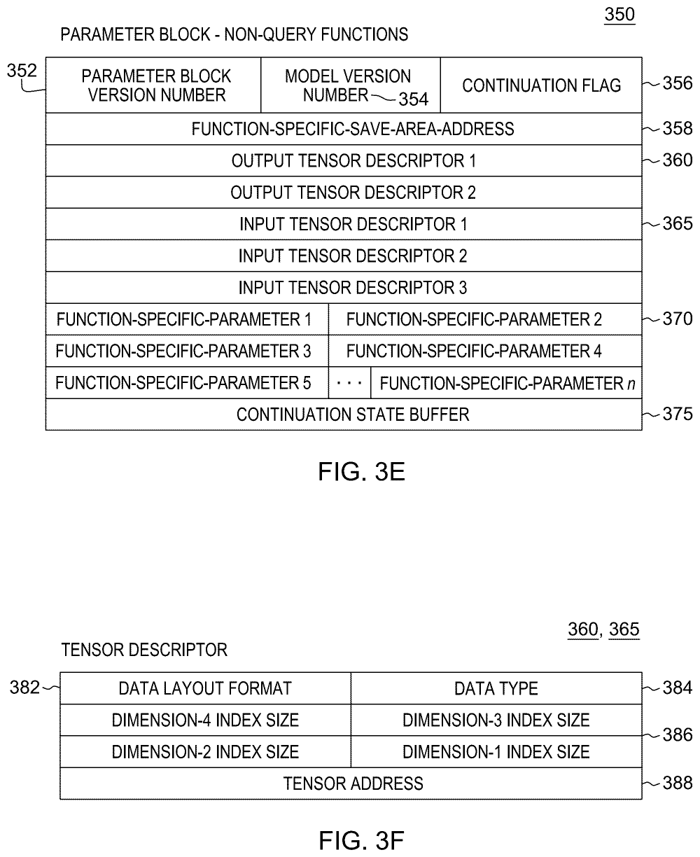

In one example, referring to FIG. 3A, a Neural Network Processing Assist instruction 300 has an RRE format that denotes a register and register operation with an extended operation code (opcode). As shown in FIG. 3A, in one example, Neural Network Processing Assist instruction 300 includes an operation code (opcode) field 302 (e.g., bits 0-15) indicating a neural network processing assist operation, for instance to perform function(s) related to tensor computation. In one example, bits 16-31 of the instruction are reserved and are to contain zeros.

In one example, the instruction uses a plurality of general registers implicitly specified by the instruction. For instance, Neural Network Processing Assist instruction 300 uses implied registers general register 0 and general register 1, examples of which are described with reference to FIGS. 3B and 3C, respectively.

Referring to FIG. 3B, in one example, general register 0 includes a function code field specifying a function code that determines the function to be performed by the instruction. Upon completion of the instruction, general register 0 contains status/exception flags and a response code that may be updated under certain conditions. As an example, general register 0 includes a response code field 310 (e.g., bits 0-15), an exception flags (or status flags) field 312 (e.g., bits 24-31), and a function code field 314 (e.g., bits 56-63). Further, in one example, bits 16-23 and 32-55 of general register 0 are reserved and are to contain zeros. One or more fields are used by a particular function performed by the instruction. Not all fields are used by all of the functions, in one example. Each of the example fields is described below:

Response Code (RC) 310: This field (e.g., bit positions 0-15) contains the response code. When execution of the Neural Network Processing Assist instruction completes with a condition code of, e.g., one, a response code is stored. When an invalid input condition is encountered, a non-zero value is stored to the response code field, which indicates the cause of the invalid input condition recognized during execution and a selected condition code, e.g., 1, is set. In some embodiments, response codes less than a defined value, for instance F000 hex, apply to all NNPA functions unless the function description states otherwise. The codes stored to the response code field are defined, as follows, in one example:

| Response Code | Meaning |
|---|---|
| 0001 | The format of the parameter block, as specified by the |
| | parameter block version number, is not supported by |
| | the model or by the specified function. |
| 0002 | The specified function is not defined or installed on the |
| | machine. |
| 0010 | A specified tensor data layout format is not supported. |
| 0011 | A specified tensor data type is not supported. |
| 0012 | A specified single tensor dimension is greater than the |
| | maximum dimension index size (MDIS) or the |
| | maximum-dimension-n-index size (MDnIS). |
| 0013 | The size of a specified tensor is greater than the |
| | maximum tensor size (MTS). |
| 0014 | The specified tensor address is not aligned on |
| | a 4K-byte boundary. |
| 0015 | The function-specific-save-area-address is not |
| | aligned on a 4K-byte boundary. |
| F000-FFFF | Function specific response codes. These response |
| | codes are defined for certain functions. |

In embodiments, there may be a specified priority at which normal and exceptional conditions are recognized by the NNPA instruction. For cases where multiple response codes may be applicable, it may be model dependent which response code is indicated.

Exception Flags (EF) 312 (Exception Flags may be interchangeably referred to herein as Status Flags (SF), and “Exception” may be interchangeably referred to herein as “Status”): This field (e.g., bit positions 24-31) includes the status flags. If an exception condition is detected during execution of the instruction, the corresponding exception flag control (e.g., bit) will be set to, e.g., one; otherwise, the control remains unchanged. The field (e.g., 312) is to be initialized to zero prior to the first invocation of the instruction. In examples, the field is initialized to zero prior to the beginning of a sequence of NNPA operations to accumulate the status across all operations of the sequence. Reserved flags are unchanged during execution of the instruction. The flags stored to the exception flags field are defined as follows, in one example:

| SF (Bit) | Meaning |
|---|---|
| 0 | Range Violation: This flag is set (e.g., to 1) when a |
| | non-numeric value was either detected in an input |
| | tensor or stored to the output tensor. This flag is, e.g., |
| | only valid when the instruction completes with |
| | condition code, e.g., 0. |
| 1-7 | Reserved. |

Function Code (FC) 314: This field (e.g., bit positions 56-63) includes the function code. Various function codes are assigned function codes for the Neural Network Processing Assist instruction. All other function codes are unassigned. If an unassigned or uninstalled function code is specified, a response code of, e.g., 0002 hex and a select condition code, e.g., 1, are set in general register 0. This field is not modified during execution.

As indicated, in addition to general register 0, the Neural Network Processing Assist instruction also uses general register 1, an example of which is depicted in FIG. 3C. As examples, bits 40-63 in the 24-bit addressing mode, bits 33-63 in the 31-bit addressing mode, or bits 0-63 in the 64-bit addressing mode include an address of a parameter block 320. The contents of general register 1 specify, for instance, a logical address of a leftmost byte of the parameter block in storage. The parameter block is to be designated on a doubleword boundary; otherwise, a specification exception is recognized. For all functions, the contents of general register 1 are not modified.

In the access register mode, access register 1 specifies an address space containing the parameter block, input tensors, output tensors and the function specific save area, as an example.

In one example, the parameter block may have different formats depending on the function specified by the instruction to be performed. For instance, a query function of the instruction can have a parameter block of one format and other functions of the instruction can have a parameter block of another format. In another example, all functions can use the same parameter block format. Other variations are also possible.

As examples, a parameter block and/or the information in the parameter block is stored in memory, in hardware registers, and/or in a combination of memory and/or registers. Other examples are also possible.

One example of a parameter block used by a function, such as a query function, such as the NNPA-Query Available Functions (QAF) operation, is described with reference to FIG. 3D. The NNPA-QAF (query) function can provide the means of indicating the availability of all installed functions, installed parameter-block formats, installed data types, installed data-layout formats, maximum-dimension-index size, and maximum-tensor size, as examples. As shown, in one example, a NNPA-Query Available Functions parameter block 330 includes, for instance:

Installed Functions Vector 332: This field (e.g., bytes 0-31) of the parameter block includes the installed functions vector. In one example, bits 0-255 of the installed functions vector correspond to function codes 0-255, respectively, of the Neural Network Processing Assist instruction. When a bit is, e.g., one, the corresponding function is installed; otherwise, the function is not installed.

Installed Parameter Block Formats (IPBF) Vector 334: This field (e.g., bytes 32-47) of the parameter block includes the installed parameter block formats vector. In one example, bits 0-127 of the installed parameter block formats vector correspond to parameter block formats 0-127 for the non-query functions of the Neural Network Processing Assist instruction. When a bit is, e.g., one, the corresponding parameter block format is installed; otherwise, the parameter block format is not installed.

Installed Data Types Vector 336: This field (e.g., bytes 48-49) of the parameter block includes the installed data types vector. In one example, bits 0-15 of the installed data types vector correspond to the data types being installed. When a bit is, e.g., one, the corresponding data type is installed; otherwise, the data type is not installed. Example data types include (additional, fewer and/or other data types are possible):

| Bit | Data Type |
|---|---|
| 0 | NNP-data-type-1 |
| 1-5 | Reserved |
| 6 | 32-bit binary-floating-point (BFP short) format |
| 7 | Reserved |
| 8 | 8-bit signed or unsigned binary integer |
| 9 | Reserved |
| 10 | 32-bit signed or unsigned binary integer |
| 11-15 | Reserved |

It is noted that binary-floating-point (BFP) may be a term used for the equivalent IEEE 754 floating-point value, e.g., IEEE 32-bit floating-point.

The NNP-data-type-1 format represents a 16-bit signed floating-point number are a format with a range and precision tailored toward neural-network processing.

In embodiments, not all installed-data types may be available to all NNPA functions. In embodiments, an installed-data type does not distinguish between whether the data type is signed or unsigned.

Installed Data Layout Formats Vector 338: This field (e.g., bytes 52-55) of the parameter block includes the installed data layout formats vector. In one example, bits 0-31 of the installed data layout formats vector correspond to data layout formats being installed. When a bit is, e.g., one, the corresponding data layout format is installed; otherwise, the data layout format is not installed. Example data layout formats include (additional, fewer and/or other data layout formats are possible):

| Bit | Data Layout Format |
|---|---|
| 0 | 4D-feature tensor |
| 1 | 4D-kernel tensor |
| 2 | 4D-weights tensor |
| 3-30 | Reserved |
| 31 | 4D-generic tensor |

In embodiments, not all installed data-layout formats are available to all NNPA functions.

Maximum Dimension Index Size 340: This field (e.g., bytes 60-63) of the parameter block includes, e.g., a 32-bit unsigned binary integer that specifies a maximum number of elements in a specified dimension index size for any specified tensor. In another example, the maximum dimension index size specifies a maximum number of bytes in a specified dimension index size for any specified tensor. Other examples are also possible.

The MDIS value is applicable when parameter-block-format 1 is not installed, and it applies to all dimensions of a tensor. When parameter-block-format 1 is installed, the individual maximum-dimension-n-index-size (MDnIS) values are applicable, as described below; in this case, MDIS contains the minimum of the MDnIS values.

Maximum Tensor Size 342: This field (e.g., bytes 64-71) of the parameter block includes, e.g., a 64-bit unsigned binary integer that specifies a maximum number of bytes in any specified tensor including any pad bytes required by the tensor format. In another example, the maximum tensor size specifies a maximum number of total elements in any specified tensor including any padding required by the tensor format. Other examples are also possible.

Installed-NNP-Data-Type-1-Conversions Vector 344: This field (e.g., bytes 72-73) of the parameter block includes the installed-NNP-Data-Type-1-conversions vector. In one example, bits 0-15 of the installed-NNP-Data-Type-1-conversions vector correspond to installed data type conversions between binary-floating point (BFP) and NNP-data-type-1 formats. When a bit is one, the corresponding conversion is installed; otherwise, the conversion is not installed. Additional, fewer, and/or other conversions may be specified.

| Bit | Data Type |
|---|---|
| 0 | Reserved |
| 1 | BFP tiny format (16 bit) |
| 2 | BFP short format (32 bit) |
| 3-15 | Reserved |

Maximum-Dimension-n-Index-Sizes (MDnIS) 346: These fields (e.g., bytes 88-103) contain four unsigned integers, e.g. of 4-bytes each, that specify the maximum number of elements in each dimension of a tensor, as follows:

| Field | Bytes | Contents |
|---|---|---|
| MD4IS | 88-91 | Maximum dimension-4 index size |
| MD3IS | 92-95 | Maximum dimension-3 index size |
| MD2IS | 96-99 | Maximum dimension-2 index size |
| MD1IS | 100-103 | Maximum dimension-1 index size |

The MDnIS fields may be stored and are applicable only when parameter-block format 1 or higher is installed; otherwise, zeros may be stored in bytes 88-103. When applicable, an individual MDnIS value may never be less than the MDIS value.

Although one example of a parameter block for a query function is described with reference to FIG. 3D, other formats of a parameter block for a query function, including the NNPA-Query Available Functions operation, may be used. The format may depend, in one example, on the type of query function to be performed. Further, the parameter block and/or each field of the parameter block may include additional, fewer and/or other information.

In addition to the parameter block for a query function, in one example, there is a parameter block format for non-query functions, such as non-query functions of the Neural-Network Processing Assist instruction. One example of a parameter block used by a non-query function, such as a non-query function of the Neural Network Processing Assist instruction, is described with reference to FIG. 3E.

As shown, in one example, a parameter block 350 employed by, e.g., the non-query functions of the Neural Network Processing Assist instruction includes, for instance:

Parameter Block Version Number 352: The parameter block 350 can include (e.g., via bits 9-15) a 7-bit (in this example) unsigned binary integer specifying the format of the parameter block. A query function can provide a mechanism of indicating the parameter block formats available. When the format of the parameter block specified is not supported by the model, a response code of, e.g., 0001 hex is set in general register 0 and the instruction completes by setting a condition code, e.g., condition code 1. The parameter block version number is specified by the program and is not modified during the execution of the instruction.

Model Version Number 354: This field (e.g., byte 2) of the parameter block is an unsigned binary integer (e.g., an 8-bit unsigned binary integer) identifying the model which executed the instruction (e.g., the particular function). When a continuation flag (described below) is set (e.g., to one), the model version number may be an input to the operation for the purpose of interpreting the contents of a continuation state buffer field (described below) of the parameter block to resume the operation.

Continuation Flag 356: This field (e.g., bit 63) of the parameter block, when, e.g., one, indicates the operation is partially complete and the contents of the continuation state buffer may be used to resume the operation. The program is to initialize the continuation flag to zero and not modify the continuation flag in the event the instruction is to be re-executed for the purpose of resuming the operation; otherwise, results are unpredictable.

If the continuation flag is set at the beginning of the operation and the contents of the parameter block have changed since the initial invocation, results are unpredictable and may include recognition of a general-operand data exception.

Function-specific-save-area-address 358: This field (e.g., bytes 56-63) of the parameter block includes the logical address of the function specific save area. In one example, the function-specific-save-area-address is to be aligned on a 4 K-byte boundary; otherwise, a response code of, e.g., 0015 hex is set in general register 0 and the instruction completes with a condition code of, e.g., 1. The address is subject to the current addressing mode. The size of the function specific save area depends on the function code.

When the entire function specific save area overlaps the program event recording (PER) storage area designation, a PER storage alteration event is recognized, when applicable, for the function specific save area. When only a portion of the function specific save area overlaps the PER storage area designation, it is model-dependent which of the following occurs:
A PER storage alteration event is recognized, when applicable, for the entire function specific save area.
A PER storage alteration event is recognized, when applicable, for the portion of the function specific save area that is stored.

When the entire parameter block overlaps the PER storage area designation, a PER storage alteration event is recognized, when applicable, for the parameter block. When only a portion of the parameter block overlaps the PER storage area designation, it is model-dependent which of the following occurs:
A PER storage alteration event is recognized, when applicable, for the entire parameter block.
A PER storage alteration event is recognized, when applicable, for the portion of the parameter block that is stored.

A PER zero-address detection event is recognized, when applicable, for the parameter block. Zero address detection does not apply to the tensor addresses or the function-specific-save-area-address, in one example.

Continuing with the description of example parameter block 350, the parameter block includes tensor descriptors for input tensors and output tensors. In this example, there are tensor descriptors for two output tensors and three input tensors. Different functions might utilize a different number of input tensors and/or output tensors. If a tensor descriptor is not used by a particular function, then the descriptor can be ignored.

Output Tensor Descriptors (e.g., 1-2) 360/Input Tensor Descriptors (e.g., 1-3) 365: One example of a tensor descriptor is described with reference to FIG. 3F. In one example, a tensor descriptor 360, 365 includes, referring to FIG. 3F:

Data Layout Format 382: This field (e.g., byte 0) of the tensor descriptor contains, e.g., an 8-bit unsigned binary integer specifying the data layout format. Valid data layout formats include, for instance (additional, fewer and/or other data layout formats are possible):

| Format | Description | Alignment (bytes) |
|---|---|---|
| 0 | 4D-feature tensor | 4096 |
| 1 | 4D-kernel tensor | 4096 |
| 2 | 4D-weights tensor | 4096 |
| 3-30 | Reserved | — |
| 31 | 4D-generic tensor | 4096 |
| 32-255 | Reserved | — |

When the alignment of a data-layout format is based on the data type, the alignment can be an integral boundary based on the size in bytes of a data element. For example, for a 4D-generic tensor having a BFP-short-format data type, the alignment is four bytes.

If an unsupported or reserved data layout format is specified, the response code of, e.g., 0010 hex, is set in general register 0 and the instruction completes by setting condition code, e.g., 1.

Data Type 384: This field (e.g., byte 1) contains, e.g., an 8-bit unsigned binary integer specifying the data type of the tensor. Examples of supported data types are described below (additional, fewer and/or other data types are possible):

| Value | Data Type | Data Size (bits) |
|---|---|---|
| 0 | NNP data-type-1 | 16 |
| 1-5 | Reserved | — |
| 6 | BFP short format | 32 |
| 7 | Reserved | — |
| 8 | Signed binary integer | 9 |
| 9 | Reserved | — |
| 10 | Signed or unsigned binary integer | 32 |
| 11-255 | Reserved | — |

If an unsupported or reserved data type is specified, a response code of, e.g., 0011 hex is set in general register 0 and the instruction completes by setting condition code, e.g., 1.

Dimension 1-4 Index Size 386: Collectively, dimension index sizes one through four specify the shape of a 4D tensor, each in the form of, e.g., a 32-bit unsigned binary integer. Each dimension index size is to be greater than zero and less than or equal to the maximum dimension index size (MDIS) (340, FIG. 3D); otherwise, a response code of, e.g., 0012 hex is set in general register 0 and the instruction completes by setting condition code, e.g., 1. In embodiments in which transformation function(s) are installed, for instance a function to transform between data-layout-formats, such as to transform a data-layout-format-31 tensor to or from a data-layout-format-0 4D-feature tensor as an example, the size of the transformed tensor (e.g., in data-layout-format 0 or data-layout-format 1) is to be less than or equal to a maximum tensor size (342, FIG. 3D); otherwise, a response code, e.g., 0013 hex is set in general register 0 and the instruction completes by setting condition code, e.g., 1.

Tensor Address 388: This field (e.g., bytes 24-31) of the tensor descriptor includes a logical address of the leftmost byte of the tensor. The address is subject to the current addressing mode.

If the tensor descriptor is used by the function, then if the address is not aligned on the boundary of the associated data layout format, a response code of, e.g., 0014 hex, is set in general register 0 and the instruction completes by setting condition code, e.g., 1.

The address is subject to the current addressing mode. In the access register mode, access register 1 specifies the address space containing all active input and output tensors in storage.

Returning to FIG. 3E, parameter block 350 further includes, in one example, function-specific-parameters (370), which may be used by specific functions, as described herein. The parameter block could contain any number n of function specific parameters, as shown by FSPs 1 through n. In specific embodiments, the architecture defines sixteen FSPs (FSP 1 through FSP 16), and thus n is 16. Different functions could use different FSPs and different numbers of FSPs, and it may be that not all defined FSPs are used. If a function does not need all function-specific-parameter fields, the unused fields could contain zeros, as an example. In addition, the number of FSPs used for a given function could have an association to the parameter-block-version number (PBVN). For instance, in some embodiments, when PBVN is zero then only FSPs 1-5 are meaningful, and when PBVN>0, then any one or more of FSPs 1-16 may be used.

Further, parameter block 350 includes, in one example, a continuation state buffer field 375, which includes data (or a location of data) to be used if operation of this instruction is to be resumed. In examples, the continuation state buffer field 375 holds intermediate results for partial completion reported by setting the condition code equal to a value, e.g., 3.

As an input to the operation, reserved fields of the parameter block should contain zeros. When the operation ends, reserved fields may be stored as zeros or remain unchanged.

Although one example of a parameter block for a function, such as a non-query function, is described with reference to FIG. 3E, other formats of a parameter block for a non-query function, including a non-query function of the Neural Network Processing Assist instruction, may be used. The format may depend, in one example, on the type of function to be performed. Further, although one example of a tensor descriptor is described with reference to FIG. 3E, other formats may be used. Further, different formats for input and output tensors may be used. Other variations are possible.

As noted, the Neural Network Processing Assist (NNPA) query function provides a mechanism to indicate selected information, such as, for instance, the availability of installed functions, installed parameter block formats, installed data types, installed data layout formats, maximum dimension index size and maximum tensor size. In execution of one embodiment of the query function, a processor, such as general-purpose processor, obtains information relating to a specific processor, such as a specific model of a neural network processor, such as neural network processor. A specific model of a processor or machine has certain capabilities. Another model of the processor or machine may have additional, fewer and/or different capabilities and/or be of a different generation (e.g., a current or future generation) having additional, fewer and/or different capabilities. The obtained information is placed in a parameter block (e.g., parameter block 330) or other structure that is accessible to and/or for use with one or more applications that may use this information in further processing. In one example, the parameter block and/or information of the parameter block is maintained in memory. In other embodiments, the parameter block and/or information may be maintained in one or more hardware registers. As another example, the query function may be a privileged operation executed by the operating system, which makes available an application programming interface to make this information available to the application or non-privileged program. In yet a further example, the query function is performed by a special-purpose processor, such as neural network processor. Other variations are possible.

The information is obtained, e.g., by the firmware of the processor executing the query function. The firmware has knowledge of the attributes of the specific model of the specific processor (e.g., neural network processor). This information may be stored in, e.g., a control block, register and/or memory and/or otherwise be accessible to the processor executing the query function.

The obtained information includes, for instance, model-dependent detailed information regarding at least one or more data attributes of the specific processor, including, for instance, one or more installed or supported data types, one or more installed or supported data layout formats and/or one or more installed or supported data sizes of the selected model of the specific processor. This information is model-dependent in that other models (e.g., previous models and/or future models) may not support the same data attributes, such as the same data types, data sizes and/or data layout formats. When execution of the query function (e.g., NNPA-QAF function) completes, condition code 0, as an example, is set. Condition codes 1, 2 and 3 are not applicable to the query function, in one example.

As indicated, in one example, the obtained information includes model-dependent information about one or more data attributes of, e.g., a particular model of a neural network processor. One example of a data attribute is installed data types of the neural network processor. For instance, a particular model of a neural network processor (or other processor) may support one or more data types, such as a NNP-data-type-1 data type (also referred to as a neural network processing-data-type-1 data type) and/or other data types, as examples. The NNP-data-type-1 data type is a 16-bit floating-point format that provides a number of advantages for deep learning training and inference computations

Although the NNP-data-type-1 data type is supported in one example, other specialized and non-standard data types may be supported, as well as one or more standard data types including, but not limited to: IEEE 754 short precision, binary floating-point 16-bit, IEEE half precision floating point, 8-bit floating point, 4-bit integer format and/or 8-bit integer format, to name a few. These data formats have different qualities for neural network processing. As an example, smaller data types (e.g., less bits) can be processed faster and use less cache/memory, and larger data types provide greater result accuracy in the neural network. A data type to be supported may have one or more assigned bits in the query parameter block (e.g., in installed data types field 336 of parameter block 330). For instance, specialized or non-standard data types supported by a particular processor are indicated in the installed data types field but standard data types are not indicated. In other embodiments, one or more standard data types are also indicated. Other variations are possible.

In embodiments, an 8-bit signed binary integer (INT8) data format is supported. Certain NNPA functions use the 8-bit signed binary integer data format having a range of −128 to +127. Arithmetic operations that result in an 8-bit signed binary integer are saturating; that is, if the result is less than −128, it is set to −128, and if the result is greater than +127, it is set to +127.

In one example, the query function obtains an indication of the data types installed on the model-dependent processor and places the indication in the parameter block by, e.g., setting one or more bits in installed data types field 336 of parameter block 330. Further, in one example, the query function obtains an indication of installed data layout formats (another data attribute) and places the information in the parameter block by, e.g., setting one or more bits in installed data layout formats field 338. Example data layout formats include, for instance, a 4D-feature tensor layout, a 4D-kernel tensor layout, and a 4D-weights tensor layout (i.e., data-layout format 2). Others are possible. The 4D-feature tensor layout is used, in one example, by the functions described herein, and in one example, the convolution function uses the 4D-kernel tensor layout. These data layout formats arrange data in storage for a tensor in a way that increases processing efficiency in execution of the functions of the Neural Network Processing Assist instruction. For instance, to operate efficiently, the Neural Network Processing Assist instruction uses input tensors provided in particular data layout formats. Although example layouts are provided, additional, fewer and/or other layouts may be provided for the functions described herein and/or other functions.

The use or availability of layouts for a particular processor model is provided by the vector of installed data layout formats (e.g., field 338 of parameter block 330). The vector is, for instance, a bit vector of installed data layout formats that allows the CPU to convey to applications which layouts are supported. In one example, the bit vector of installed data layout formats is configured to represent up to 16 data layouts, in which a bit is assigned to each data layout. However, a bit vector in other embodiments may support more or fewer data layouts. Further, a vector may be configured in which one or more bits are assigned to data layouts. Many examples are possible.

In one example, the Neural Network Processing Assist instruction operates with 4D-tensors, meaning tensors with 4 dimensions. These 4D-tensors are obtained from generic input tensors in row-major format, meaning that, when enumerating the tensor elements in increasing storage-address order, the inner dimension called E1 will be stepped up/incremented first through the E1-index-size values starting with 0 through the E1-index-size-1, before the index of the E2 dimension will be increased and the stepping through the E1 dimension is repeated. The index of the outer dimension called the E4 dimension is increased last. As one alternative to the row-major format, another format in which elements are provided in increasing memory address order is a ‘column-major’ formatted tensor format, which may be another example of a generic format. For a generic input tensor in column-major format, when enumerating the tensor elements in increasing storage-address order, the column dimension (e.g., E2) will be stepped up/incremented first through the E2-index-size values starting with 0 through the E2-index-size-1, before the index of another dimension, such as the row (E1) dimension, will be increased, and then stepping through the E2 dimension is repeated. The index of the outer dimension (e.g., E4 dimension) is increased last. Both the row-major format and the column-major format are examples of a tensor format in which elements are provided in increasing memory address order.

Tensors that have a lower number of dimensions (e.g., 3D-, 2D, or 1D-tensors) will be represented as 4D-tensors the index size of the unused dimensions set to 1.

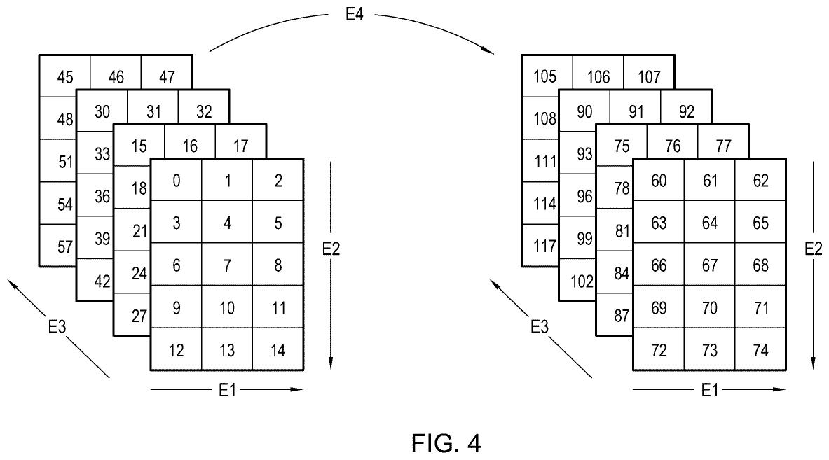

An example of a generic tensor is shown in FIG. 4. The four dimensions of the tensor are denoted E4, E3, E2, and E1. Each element of the tensor (shown as integers starting at value 0) is contiguous in storage. As an example, the element [1][0][2][1] is the value 67.

The row-format generic tensor, such as that of FIG. 4, is considered to be in data-layout-format 31, discussed elsewhere herein. In embodiments in which transformation function(s) are installed, for instance a function to transform between data-layout-formats, this can be used to transform a data-layout-format-31 generic tensor to and from a data-layout-format-0 4D-feature tensor.

Sticks, Stickification, and Elements Per Stick (eps): Tensors that have been transformed into any of one or more specific layouts, such as an NNP data layout—that is, tensors that have been structured such that the E1 and E2 dimensions are optimally sized for processing by the NNPA instruction—are referred to as “stickified” tensors, meaning their E1 dimensions, referred to as “sticks”, are of a fixed size. In some examples, the fixed-size is derived from a Single Instruction, Multiple Data (SIMD) path width in the hardware, though this is by way of example only, and not limitation. This provides a ‘tile’-like format that organizes the elements in fixed-size width vectors grouped/arrayed by a fixed-size number of these vectors. Conversely, generic tensors that have not been transformed may be referred to as “unstickified” tensors. In example processor models, the size of a stick (“stick size” or “stick_size”) is, e.g., 128 bytes.

In some data-layout-formats, such as data-layout-formats 0, 1, and 2 discussed herein, the maximum number of elements per stick (eps) is determined based on the stick size and the size of the elements (“element size” or “element_size”) as follows:

$$eps = stick\_size / element\_size$$

In examples, the element size is derived from the data type. The elements per stick for example data types are shown by Table 1:

TABLE 1

| Data Type | | | Elements Per |
|---|---|---|---|
| Code | Name | Size (bytes) | Stick (eps) |
| 0 | NNP Data-Type 1 | 2 | 64 |
| 6 | 32-bit BFP-short format | 4 | 32 |
| 8 | 8-bit signed binary integer | 1 | 128 |
| 10 | 32-bit binary integer | 4 | 32 |

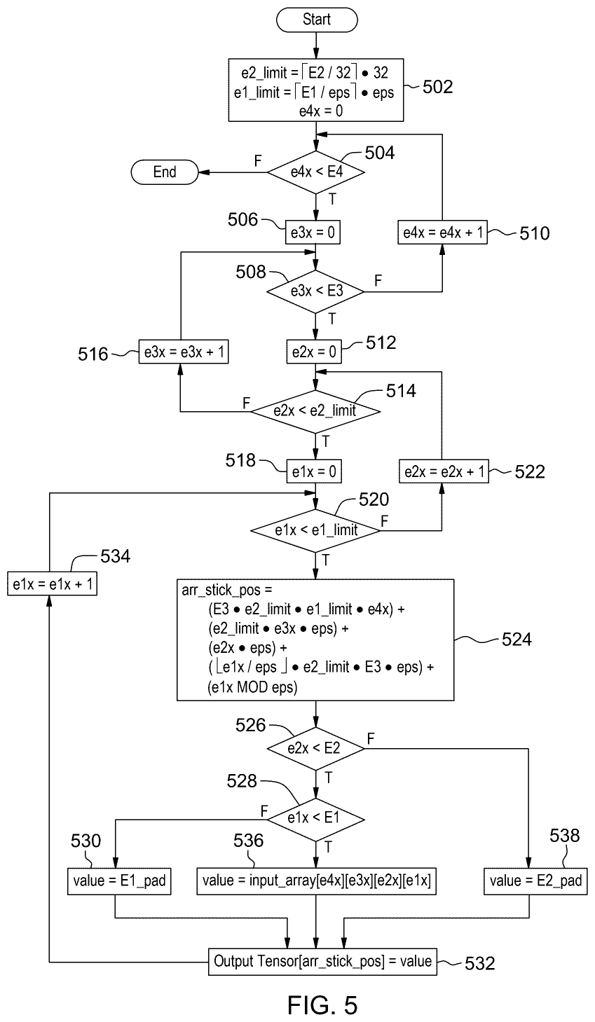

Data-Layout-Format-0: A process for the transformation of a row-major generic 4D-tensor with dimensions E4, E3, E2, E1 (an example of which is depicted by FIG. 4) into an NNPA data-layout-format-0 4D-feature tensor (also referred to herein as NNPA data layout format 0 4D-feature tensor) is depicted by FIG. 5. The process begins with setting (502) e2_limit=┌E2/32┐*32, e1_limit=┌E1/eps┐*eps, and e4x=0. ┌n┐ or ceil(n) refers to the ceiling (or “ceil”) function, that is an integer result with no fraction, and is taken as the smallest integer larger or equal to n. It is determined at 504 whether e4x<E4, and if not (504, F), the process ends. Otherwise (504, T), the process sets (506) e3x=0 and determines (508) whether e3x<E3. If not (508, F), the process sets (510) e4x=e4x+1 and returns to 504. Otherwise (508, T), the process sets (512) e2x=0 and determines (514) whether e2x<e2_limit. If not (514, F), the process sets (516) e3x=e3x+1 and returns to 508. Otherwise (514, T), the process sets (518) e1x=0, then determines (520) whether e1x<e1_limit. If not (520, F), the process sets (522) e2x=e2x+1 and returns to 514. Otherwise (520, T), the process sets arr_stick_pos=(E3*e2_limit*e1_limit*e4x)+(e2_limit*e3x*eps)+(e2x*eps)+(└e1x/eps┘*e2_limit*E3*eps)+(e1x MOD eps). └n┘ or floor(n) refers to the floor function, that is an integer result with no fraction, and is taken as the greatest integer less than or equal to n. Mod or MOF is modulo. The process continues by determining (526) whether e2x<E2. If not (526, F), the process sets (538) value=E2_pad. If instead at 526 it is determined that e2x is less than E2 (526, T), the process determines (528) whether e1x<E1. If not (528, F), the process sets (530) value=E1_pad. Otherwise, (528, T), the process sets (536) value=input_array[e4x][e3x][e2x][e1x]. After a value is set (either by 530, 536, or 538), the process continues by setting (532) OutputTensor [arr_stick_pos]=value, setting (534) e1x=e1x+1, then returning to 520.

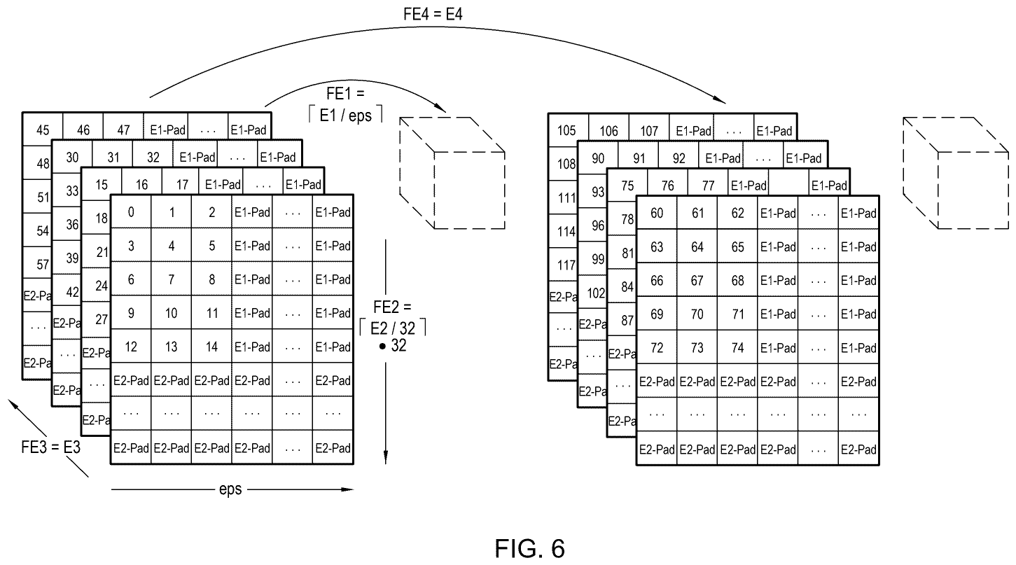

An example of a NNPA data-layout-format-0 4D-feature tensor is depicted by FIG. 6. The feature tensor of FIG. 6 has dimensions E4, ┌E1/eps┐, E3, ┌E2/32┐*32,eps. As an example, the element [1][0][0][2][1] is the value 67. Cells labeled E1-Pad are E1 padding, while cells labeled E2-Pad are E2 padding. eps refers to elements per stick, for example 64 for NNP-data-type 1, and 128 for INT8. As noted, ┌n┐ refers to the ceil function.

Thus, a resulting transformed generic tensor can be represented, for instance, as a 4D-tensor of eps-element vectors, for instance 64-element vectors as an example, or a 5D-tensor with dimensions:

E4, ┌E1/eps┐, E3, ┌E2/32┐*32, eps. Another way of stating the preceding in examples is: E4*E3*ceil (E2/32)*32*ceil (E1/eps)*eps elements.

The total size, in elements of the resulting tensor, is the product of these five dimensions.

An element [e4][e3][e2][e1] of the generic tensor may be mapped to the following element of the resulting 5D-tensor:

[e4][└e1/eps┘][e3][e2][e1 MOD eps], where └ ┘ is the floor function and
mod is modulo. Another way of stating the preceding in examples is:
element (E3 * e2_limit * e1_limit * e4x) + (e2_limit * e3x * eps) + (e2x
* eps) + (└ e1x/eps┘ * e2_limit * E3 * eps) + (e1x mod eps), where
e2_limit = ┌E2/32┐ * 32 and e1_limit = ┌E1/eps┐ * eps.)

The resulting tensor may have more elements than the generic tensor. Elements of the resulting tensor with no corresponding elements in the generic tensor are called pad elements.

Consider the element [fe4][fe1][fe3][fe2][fe0] of a NNPA data layout format 0 4D-feature tensor of a eps-element vectors or its equivalent representation as a 5D-tensor of elements. This element is either a pad element or its corresponding element in the generic 4D tensor with dimensions E4, E3, E2, E1 can be determined with the following formula:
if fe2≥E2 then this is an E2 (or page)-pad element
else if fe1*eps+fe0≥E1 then this is an E1 (or row)-pad element
else the indices of the corresponding element in the generic 4D tensor are: [fe4][fe3][fe2][fe1*eps+fe0]

Alternatively, consider the element at offset dlf0_off of an NNPA data layout format 0 4D-feature tensor. This element is either a pad element or its corresponding element in the generic 4D-tensor with dimensions E4, E3, E2, E1 and can be determined as follows:

```
  if dlf0_off MOD (┌E1/32┐ * 32 * eps) ≥ E2 * eps then this is an
E2-pad element
  else:
  - area3d = E3*┌E2/32┐*32*┌E1/eps┐*eps
  - rem3d = dlf0_off MOD area3d
  - if(└ rem3d / (E3 * ┌E2/32┐ * 32 * eps)┘ == └ E1/
eps┘ AND rem3d MOD eps ≥ E1 MOD eps) then this is an E1-pad
element.
  else: the corresponding element in the generic 4D-tensor is:
[└ dlf0_off/ (┌E1/eps┐ * E3 * ┌E2/32┐ * 32 * eps)┘]
[(└ dlf0_off/ (┌E2/32┐ * E2 * eps)┘ MOD E3]
[(└ dlf0_off/ eps)┘ MOD (┌E2/32┐ * 32)]
[(└ dlf0_off/ (E3 * ┌E2/32┐ * 32 * eps)┘ MOD ┌E1/eps┐) * eps
    + (dlf0_off MOD eps)]
```

Pad elements are ignored for the input tensors and model dependent for output tensors. It is model dependent if PER storage-alteration is detected on pad elements of output tensors.

For convolutional neural network based artificial intelligence models, the meaning of the 4 dimensions of a feature tensor can generally be mapped to:
E4: N—Size of mini-batch
E3: H—Height of the 3D-tensor/image
E2: W—Width of the 3D-tensor/image
E1: C—Channels or classes of the 3D-tensor

For machine learning or recurrent neural network based artificial intelligence models, the meaning of the 4 dimensions of a 4D-feature tensor (data-layout-format 0) may generally be mapped to:
E4: T—Number of time-steps or models
E3: Reserved, generally set to 1
E2: N_{mb}—Minibatch size
E1: L—Features

The NNPA data layout format 0 provides, e.g., two dimensional data locality with 4 k-Bytes blocks of data (pages) as well as 4 k-Byte block data alignment for the outer dimensions of the generated tensor.

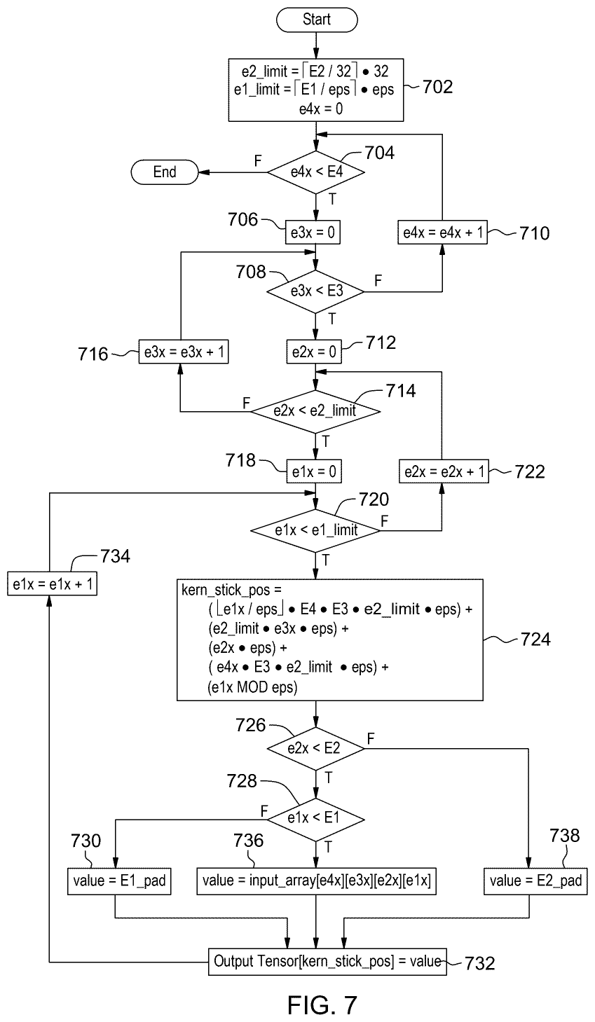

Data-Layout-Format-1: In addition to the 4D-feature tensor layout (data-layout-format 0), in one example, a neural network processor may support a 4D-kernel tensor, which re-arranges the elements of a 4D-tensor to reduce the number of memory accesses and data gathering steps when executing certain artificial intelligence (e.g., neural network processing assist) operations, such as a convolution. A process for the transformation of a row-major generic 4D-tensor with dimensions E4, E3, E2, E1 (an example of which is depicted by FIG. 4) into an NNPA data-layout-format 1 4D-kernel tensor (also referred to herein as NNPA data layout format 1 4D-kernel tensor) is depicted by FIG. 7. The process begins with setting (702) e2_limit=┌E2/32┐*32, e1_limit=┌E1/eps┐*eps, and e4x=0. It is determined at 704 whether e4x<E4, and if not (704, F), the process ends. Otherwise (704, T), the process sets (706) e3x=0 and determines (708) whether e3x<E3. If not (708, F), the process sets (710) e4x=e4x+1 and returns to 704. Otherwise (708, T), the process sets (712) e2x=0 and determines (714) whether e2x<e2_limit. If not (714, F), the process sets (716) e3x=e3x+1 and returns to 708. Otherwise (714, T), the process sets (718) e1x=0, then determines (720) whether e1x<e1_limit. If not (720, F), the process sets (722) e2x=e2x+1 and returns to 714. Otherwise (720, T), the process sets (724) kern_stick_pos=(└e1x/eps┘*E4*E3*e2_limit*eps)+(e2_limit*e3x*eps)+(e2x*eps)+(e4x*E3*e2_limit*eps)+(e1x MOD eps). The process continues by determining (726) whether e2x<E2. If not (726, F), the process sets (738) value=E2_pad. If instead at 726 it is determined that e2x is less than E2 (726, T), the process determines (728) whether e1x<E1. If not (728, F), the process sets (730) value=E1_pad. Otherwise, (728, T), the process sets (736) value=input_array[e4x][e3x][e2x][e1x]. After a value is set (either by 730, 736, or 738), the process continues by setting (732) OutputTensor [kern_stick_pos]=value, setting (734) e1x=e1x+1, then returning to 720.

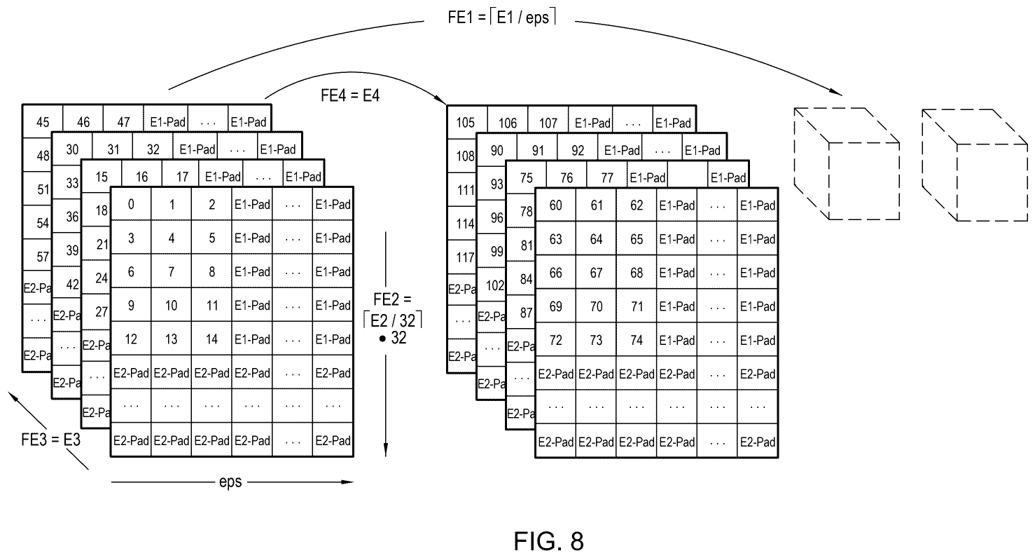

An example of a NNPA data-layout-format-1 4D-kernel tensor is depicted by FIG. 8. The kernel tensor of FIG. 8 has dimensions ┌E1/eps┐, E4, E3, ┌E2/32┐*32, eps. As an example, the element [0][1][0][2][1] is the value 67. Cells labeled E1-Pad are E1 padding, while cells labeled E2-Pad are E2 padding. eps refers to elements per stick, for example 64 for NNP-data-type 1, and 128 for INT8.

A resulting tensor can be represented as a 4D-tensor of, e.g., eps-element vectors or a 5D-tensor with dimensions FE1, FE4, FE3, FE2, FE0 respectively equal to:

┌E1/eps┐, E4, E3, ┌E2/32┐*32, eps, where ┌ ┐ refers to the ceil function. Another way of stating the preceding in examples is: E4*E3*ceil (E2/32)*32*ceil (E1/eps)*eps elements.)

The total size, in elements of the resulting tensor, is the product of these five dimensions.

An element [e4][e3][e2[e1] of the generic tensor may be mapped to the following element of the resulting 5D-tensor:

[└e1/eps┘][e4][e3][e2][e1 MOD eps], where └ ┘ refers to the floor
function and mod is modulo. Another way of stating the preceding in
examples is:
element (└e1x/eps┘ * E4 * E3 * e2_limit * eps) + (e4x * E3 * e2_limit *
eps) + (e3x * e2_limit * eps) + (e2x * eps) + (e1x mod eps), where
e2_limit = ┌E2/32┐ * 32 and e1_limit = ┌E1/eps┐ * eps.

The resulting tensor may have more elements than the generic tensor. Elements of the resulting tensor with no corresponding elements in the generic tensor are called pad elements.

Consider the element [fe1][fe4][fe3][fe2][fe0] of a NNPA data layout format 1 4D-feature tensor of eps element vectors or its equivalent representation as a 5D-tensor of elements. This element is either a pad element or its corresponding element in the generic 4D tensor with dimensions E4, E3, E2, E1 can be determined with the following formula:

```
  if fe2 ≥ E2 then this is an E2 (or page)-pad element
  else if fe1*eps+fe0 ≥ E1 then this is an E1 (or row)-pad element
  else the indices of the corresponding element in the generic 4D tensor
  are:
[fe4][fe3][fe2][fe1*eps+fe0].
```

Alternatively, consider the element at offset dlf1_off of an NNPA data layout format 1 4D-feature tensor. This element is either a pad element or its corresponding element in the generic 4D-tensor with dimensions E4, E3, E2, E1 and can be determined as follows:

```
  if dlf1_off MOD (┌E2/32┐ * 32 * eps) ≥ E2 * eps then this is an
E2-pad element
  else:
  - area4d = E4*E3*┌E2/32┐*32*┌E1/eps┐*eps
  - rem4d = dlf0_off MOD area4d
  - if (└ rem3d / (E4 * E3 * ┌E2/32┐ * 32 * eps)┘ == └ E1/
eps┘ AND rem3d MOD eps ≥ E1 MOD eps) then this is an E1-pad
element.
  else: the corresponding element in the generic 4D-tensor is:
[└ dlf1_off/ (E3 * ┌E2/32┐ * 32 * eps)┘ MOD E4]
[(└ dlf1_off/ (┌E2/32┐ * E2 * eps)┘) MOD E3]
[(└ (dlf1_off/ eps)┘) MOD (┌E2/32┐ * 32)]
[└ dlf1_off/ (E4 * E3 * ┌E2/32┐ * 32 * eps)┘ * eps + (dlf1_off MOD
eps)].
```

Pad elements may be ignored for the input tensors and model dependent for output tensors. It is model dependent if PER storage-alteration is detected on pad elements of output tensors.

For convolutional neural network based artificial intelligence models, the meaning of the 4 dimensions of a kernel tensor (data-layout-format 1) can generally be mapped to:
E4: H—Height of the 3D-tensor/image
E3: W—Width of the 3D-tensor/image
E2: C—Number of Channels of the 3D-tensor
E1: K—Number of Kernels

The NNPA data layout format 1 provides, e.g., two dimensional kernel parallelism within 4 k-Byte blocks of data (pages) as well as 4 k-Byte block data alignment for the outer dimensions of the generate tensor for efficient processing.

Data-Layout-Format-2: In data-layout-format 2, the data type specifies an element size, e.g., of one byte, and the elements in even/odd rows are paired in storage. For example, elements in dimensions [E2,E1] appear in storage in the following order: [0,0], [1,0], [0,1], [1,1], [0,2], [1,2], and so forth.

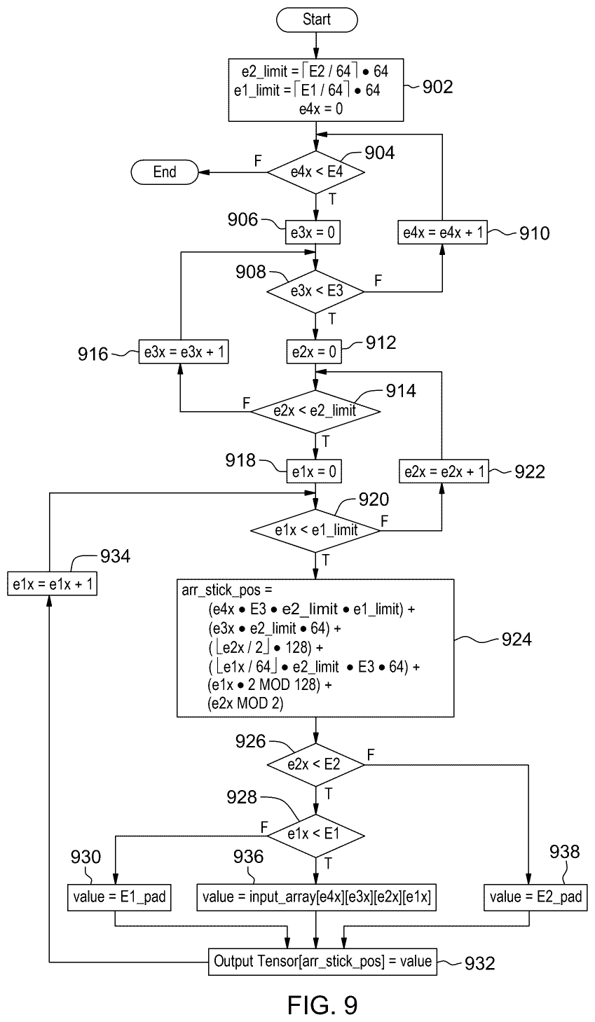

A process for the transformation of a row-major generic 4D-tensor with dimensions E4, E3, E2, E1 (an example of which is depicted by FIG. 4) into an NNPA data-layout-format 2 4D-weights tensor is depicted by FIG. 9. The process begins with setting (902) e2_limit=┌E2/64┐*64, e1_limit=┌E1/64┐*64, and e4x=0. It is determined at 904 whether e4x<E4, and if not (904, F), the process ends. Otherwise (904, T), the process sets (906) e3x=0 and determines (908) whether e3x<E3. If not (908, F), the process sets (910) e4x=e4x+1 and returns to 904. Otherwise (908, T), the process sets (912) e2x=0 and determines (914) whether e2x<e2_limit. If not (914, F), the process sets (916) e3x=e3x+1 and returns to 908. Otherwise (914, T), the process sets (918) e1x=0, then determines (920) whether e1x<e1_limit. If not (920, F), the process sets (922) e2x=e2x+1 and returns to 914. Otherwise (920, T), the process sets (924) arr_stick_pos=(e4x*E3*e2_limit*e1_limit)+(e3x*e2_limit*64)+(└e2x/2┘*128)+ (└e1x/64┘*e2_limit*e3*64)+(e1x*2 MOD 128)+(e2x MOD 2). The process continues by determining (926) whether e2x<E2. If not (926, F), the process sets (938) value=E2_pad. If instead at 926 it is determined that e2x is less than E2 (926, T), the process determines (928) whether e1x<E1. If not (928, F), the process sets (930) value=E1_pad. Otherwise, (928, T), the process sets (936) value=input_array[e4x][e3x][e2x][e1x]. After a value is set (either by 930, 936, or 938), the process continues by setting (932) OutputTensor [arr_stick_pos]=value, then sets (934) e1x=e1x+1, before returning to 920.

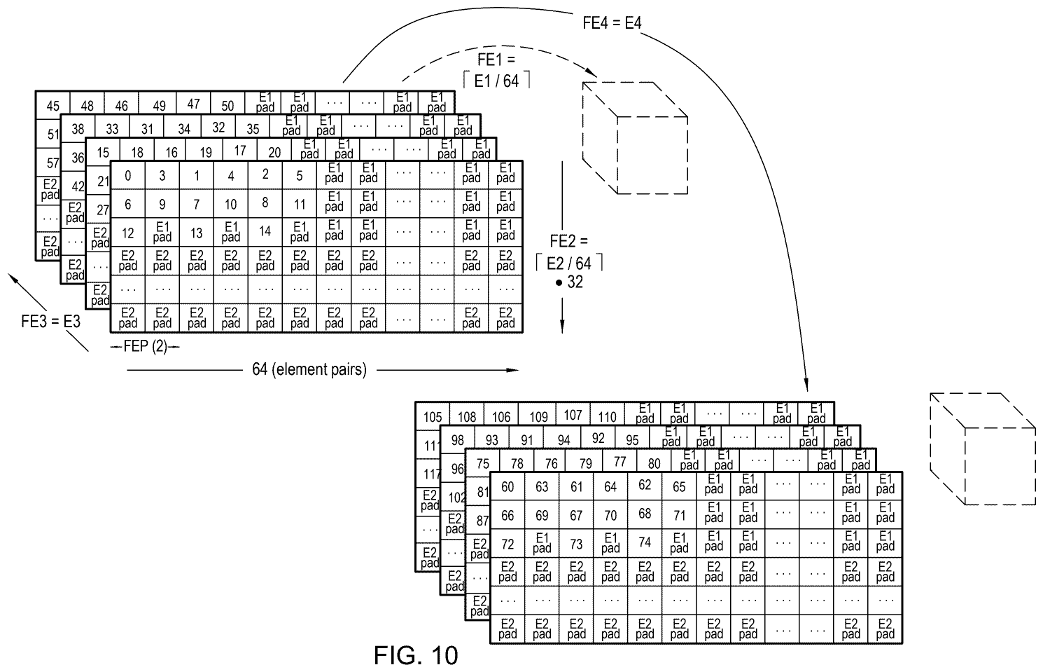

An example of an NNPA data-layout-format-2 4D-weights tensor is depicted by FIG. 10. The weights tensor of FIG. 10 has dimensions, in this example, of E4, ┌E1/64┐, E3, ┌E2/64┐*32, 64, 2. As an example, the element [1][0][0][2][1][0] is the value 67. Cells labeled E1-Pad are E1 padding, while cells labeled E2-Pad are E2 padding.

The resulting tensor can be represented as a 4D-tensor of 64 element-pair vectors or a 6D-tensor with dimensions FE4, FE1, FE3, FE2, FE0, FEP respectively equal to E4, ┌E1/64┐, E3, ┌E2/64┐*32, 64, 2.

An element [e4][e3][e2][e1] of the generic tensor will be mapped to the following element of the resulting 6D-tensor: [e4][└e1/64┘][e3][└e2/2┘][e1 MOD 64][e2 MOD 2].

The resulting tensor may have more elements than the generic tensor. All elements of the resulting tensor with no corresponding elements in the generic tensor are called pad elements.

Consider the element [fe4][fe1][fe3][fe2][fe0][fep] of a 6D representation of an NNPA data-layout-format-2 or -3 4D-weights tensor. This element is either a pad element or its corresponding element in the generic 4D tensor with dimensions E4, E3, E2, E1, and can be determined with the following formula:

```
  if: fe2 * 2 + fep ≥ ┌E2 + 1/2┐*2, then this is an E2-pad element.
  else if: fe2 * 2 + fep ≥ E2, or fe1*64+ fe0 ≥ E1, then this is a E1-pad
  element
  else: the indices of the corresponding element in the generic 4D-tensor
are: [ fe4 ] [ fe3 ] [ fe2 * 2 + fep] [ fe1 * 64 + fe0].
```

Alternatively, consider the element at offset dlf2_off of an NNPA data-layout-format-2 or -3 4D-weights tensor. This element is either a pad element or its corresponding element in the generic 4D-tensor with dimensions E4, E3, E2, E1. To simplify the process of converting an offset of a 4D-weights tensor into the indices of a 4D-generic tensor, the prospective indices may first be determined as follows:

```
  e2_limit = ┌E2/64┐* 64
  e1_limit = ┌E1/64┐ * 64
  area_3d = E3 * e2_limit * e1_limit
  e4x = └dlf2_off/area_3d┘
  e3x = └dlf2_off/ (e2_limit * 64)┘ MOD E3
  e2x = └dlf2_off/128┘ MOD └e2_limit/2┘ * 2 + dlf2_off MOD 2
  e1x = └dlf2_off/ (E3 * e2_limit * 64)┘ MOD └e1_limit/64┘ * 64 +
└dlf2_off/2┘ MOD 64.
```

The determination of whether an offset is a pad element or an element in the 4D-generic tensor is as follows:

```
  if: e2x >= (E2 + 1) / 2 * 2, then this is an E2-pad element.
  if (e2x >= E2) OR (e1x >= E1), then this is an E1-pad element
  else the corresponding element in the generic 4D-tensor is [e4x] [e3x]
[e2x] [e1x].
```

Pad elements may be ignored for the input tensors and model dependent for output tensors. It is model dependent if PER storage-alteration is detected on pad elements of output tensors.

Data-Layout-Format-31: As noted elsewhere herein and as described previously, a data-layout-format-31 tensor is a row-format generic tensor, that is, an unstickified tensor without padding. In embodiments, a transformation function can be used to transform tensors, for instance to transform a data-layout-format 31 tensor to and from a data-layout-format-0 4D-feature tensor.

Again, although example data layout formats are provided herein, other data layout formats may be supported by the processor (e.g., neural network processor).

As noted previously, a query function may be provided that conveys detailed information, for instance information relating to a specific model of a selected processor (e.g., neural network processor). The detailed information can include, for instance, model-dependent information relating to a specific processor. (A processor may also support standard data attributes, such as standard data types, standard data layouts, etc., which are implied and not necessarily presented by the query function, although, in another embodiment, the query function may indicate all or various selected subsets of data attributes, etc.) Although example information is provided, other information may be provided in other embodiments. The obtained information, which may be different for different models of a processor and/or of different processors, can be used to perform artificial intelligence and/or other processing. A specific non-query function employed in the processing is performed by executing the Neural Network Processing Assist instruction one or more times and specifying the non-query specific function.

Further details of some example non-query functions supported by the Neural Network Processing Assist instruction are now described. Specifically, some such functions perform matrix-multiplication functions (NNPA-MATMUL functions) on tensors. Example functions are the NNPA-MATMUL-OP (with Function Code 113), NNPA-MATMUL-OPBCAST23 (with Function Code 114), and NNPA-MATMUL-OPBCAST1 (with Function Code 115), as described herein. With respect to these functions, the NNPA parameter block in storage can include elements discussed herein, such as PBVN, descriptor(s) of one or more input tensors (such as descriptors as shown by the example of FIG. 3F), an output tensor descriptor (such as a descriptor as shown by the example of FIG. 3F), function specific parameter(s) to specify an OPERATION (e.g., as FSP 1), transposition control (e.g., as FSP 2), and/or other function specific parameters, as desired, including function specific parameters for various values used for quantization. In a specific example, the parameter block in storage is that of the example shown by FIG. 3E. In a more specific example, values for a_scale, a_offset, b_scale, y_scale, clip_min, and clip_max are specified in function specific parameters 3, 4, 5, 7, 9, and 10, respectively.

Some architectures might provide functions for operating on tensors in specific formats (e.g., data-layout-format 0 and/or data types (e.g., NNP-data-type 1 (16-bit float)). However, some neural-network applications do not need the resolution of, e.g., 16-bit float. For instance, an 8-bit signed binary integer tensor may be adequate for input weights tensor(s), for example both or just one of two input tensors to be matrix-multiplied. Performance benefits may be achieved by using smaller tensor operands, which can reduce memory pressure and data bandwidth, and allow for increased operations per cycle. Seamless format conversion (quantization) as part of instruction execution also helps increase performance.

Thus, in accordance with aspects described herein, matrix-multiplication functions, such as the example NNPA-MATMUL functions described herein, are enhanced to select which types of data-layout formats and data types are utilized. This may be based on a combination of, as examples: the parameter-block version number, the data-layout formats of the input and output tensors, and the data types of the input and output tensors. In examples, function-specific parameters (FSPs) are defined to implement this selection. The FSPs could be previously defined as reserved, and expected to contain zeros. This can help achieve and ensure compatibility by providing for legacy architecture behavior when these FSPs contain zeros. In accordance with aspects described herein, when mixing data types, quantization of input elements is provided. For certain data-type combinations, clipping is also provided.

In some examples, the aspects apply to tensors in data-layout-format 0 (4D feature tensor) or data-layout-format 2 (4D-weights-paired-elements, when input-tensor 2 data type is, e.g., INT8) and tensors with data types data-type 0 (NNP-data-type 1) or data-type 8 (unsigned 8-bit binary integer, optional for input tensors 1 and 2), though other DLFs and DTs may be supported.

In specific examples, two input tensors are matrix-multiplied in a format (e.g. INT8) that is shorter in length than a longer format. At some point, intermediate results are accumulated in a longer format (e.g., 16-bit floating point) and then a scaling is performed on the accumulation. Then, a fused operation with a third input tensor may be performed. For instance, elements of the third input tensor may be added to or compared with the scaled results.

In the context of NNPA-MATMUL functions, each element in the output-tensor 1 is computed as described below:
A dimension-A vector is selected from the input-tensor-1 using the get-dimension-A-vector operation (described below).
A dimension-B vector is selected from the input-tensor-2 using the get-dimension-B-vector operation (described below).
An intermediate dot product of the dimension-A vector and the dimension-B vector is computed using the dot product operation. When function-specific-parameters, such as FSPs 3, 5, and 7, are applicable, the intermediate dot product is scaled by a factor M. The dot-product operation is described below.

Processing of the intermediate dot product depends on the NNPA-MATMUL function specified, as described below. Where applicable, the fused operation is determined by a function-specific parameter, such as FSP 1.
NNPA-MATMUL-OP: A fused operation is performed on the intermediate dot product and the element of input-tensor 3 with the same dimension-index-4 value and dimension-index-1 value as output-tensor 1.
NNPA-MATMUL-OP-BCAST23: When the parameter-block-version number is, e.g., zero, the element of input-tensor 3 with the same dimension-1-index value as output-tensor-1 element is added to the previously-computed intermediate dot product and stored in output-tensor 1. When the parameter-block-version number is, e.g., greater than zero, a fused operation is performed on the intermediate dot product and the element of input-tensor 3 with the same dimension-1-index value as output-tensor 1.

NNPA-MATMUL-OP-BCAST1: When the parameter-block-version number is, e.g., zero, the function is not available. In this case, a response code, e.g., 0001 hex, is set in general register 0, and the instruction completes with a condition code, e.g., 1. When the parameter-block-version number is, e.g., greater than zero, a fused operation is performed on the intermediate dot product and the element of input-tensor 3 with the same dimension-4-index value and dimension-1-index value as output-tensor 1.

In examples, regardless of the function, the resulting element is stored in output-tensor 1.

In some embodiments, there are valid combinations of parameter-block-version number, data-layout format, data type, and applicable function-specific parameters (FSPs). A function-specific parameter may be applicable to the NNPA-MATMUL functions when its contents are used in the manipulation of an input tensor's elements (that is, when it is used to perform any of transposition, scaling, offsetting, or clipping, as examples). If the function-specific parameter is not applicable, it may have no effect on the contents of an input tensor's elements.

Example valid combinations based on parameter-block-version number are provided as follows:
PBVN=0, IT_1 (Input tensor 1), IT_2 (Input tensor 2), IT_3 (Input tensor 3), and OT_1 (Output tensor 1) have data-layout-format (DLF)=0 and data type (DT)=0, the OPERATION (OP) is specified in FSP1, and other FSPs (for instance FSP 2 through 10) are not applicable for the specified parameter-block version number, data-layout format, and data-type;
PBVN=1, IT_1, IT_2, IT_3, and OT_1 have DLF=0 and DT=0, the OP is specified in FSP1, TC is specified in FSP2, and other FSPs (for instance FSP 3 through 10) are not applicable for the specified parameter-block version number, data-layout format, and data-type;
PBVN=1, IT_1, IT_3 and OT_1 have DLF=0 and DT=0, IT_2 has DLF=2 and DT=8, the OP is specified in FSP1, a_scale is specified in FSP3, a_offset is specified in FSP4, b_scale is specified in FSP5, y_scale is specified in FSP 7, clip_min is specified in FSP9, clip_max is specified in FSP 10, and other FSPs (for instance FSP2, FSP6 and FSP8) are not applicable for the specified parameter-block version number, data-layout format, and data-type; and
PBVN=1, IT_3 and OT_1 have DLF=0 and DT=0, IT_1 has DLF=0 and DT=8, IT_2 has DLF=2 and DT=8, the OP is specified in FSP1, a_scale is specified in FSP3, b_scale is specified in FSP5, y_scale is specified in FSP 7, and other FSPs (for instance FSP2, FSP4, FSP6 and FSP 8 through 10) are not applicable for the specified parameter-block version number, data-layout format, and data-type; where:
PBVN refers to the parameter-block-version number specified in the parameter block;
DLF refers to the data-layout format specified in the tensor descriptor (e.g., 0=4D-feature tensor, 2=4D-weights tensor, as examples);
DT refers to data type specified the tensor descriptor (e.g., 0=NNP-data-type 1, 8=8-bit signed binary integer, as examples)
a_format is, when applicable, an NNPA-data-type-1 value in, e.g., bits 16-31 of FSP 4, used by the get-dimension-A-vector operation;
a_scale is, when applicable, an NNPA-data-type-1 value in, e.g., bits 16-31 of FSP 3, used by the get-dimension-A-vector and dot-product operations;
b_scale is, when applicable, when applicable, an NNPA-data-type-1 value in, e.g., bits 16-31 of FSP 5, used by the dot-product operation;
clip_max is, when applicable, when applicable, an 8-bit signed binary integer in, e.g., bits 24-31 of FSP 10, used by the dot-product operation;
clip_min is, when applicable, an 8-bit signed binary integer in, e.g., bits 24-31 of FSP 9, used by the dot-product operation;
FSPs 2 through 10 may be applicable when the parameter-block-version number is greater than, e.g., 0, as above;
OPERATION (OP) is indicated by an 8-bit unsigned binary integer in FSP 1, used by the fused operation. When the PBVN is 0, this field is not applicable to the NNPA-MATMUL-OP-BCAST23 function, as described herein;
TC refers to transposition control (e.g., a TC1 and TC2) referring to, when applicable, a one-bit binary flag in bit 31 of FSP 2 used by the get-dimension-A-vector operation (in the case of TC1) and a one-bit binary flag in bit 30 of FSP 2 used by the get-dimension-B-vector operation (in the case of TC2); and
y_scale is, when applicable, an NNPA-data-type-1 value in, e.g., bits 16-31 of FSP 7, used by the dot-product operation.

Dot-Product Operation: The intermediate dot product of two vectors of the same size is computed as the summation of products of each element in the dimension-A vector and the corresponding element of the dimension-B vector. The two input vectors to the dot-product operation are the results of the get-dimension-A-vector operation and the get-dimension-B-vector operation.

When function-specific parameters, e.g., FSP 3, FSP 5, and FSP 7 (a_scale, b_scale, and y_scale) discussed above are applicable, a scaling factor (M) is determined as follows: M=y_scale/(a_scale*b_scale).

In this case, each element of the intermediate dot product is multiplied by the scaling factor M.

If the calculation of the scaling factor results in a value of M that is zero or a nonnumeric value of either sign, a response code, e.g., F002 hex, is set in general register 0, and the instruction completes with a condition code, e.g., 1.

Fused Operation: Bits, e.g., bits 24-31 of function-specific-parameter 1, contain an 8-bit unsigned binary integer that controls the operation performed on the intermediate dot product (scaled by M when applicable) and the corresponding element from input-tensor 3.

The OPERATION field, as discussed above, specifies the operation performed. Example such operation values and type are as follows:

| Operation | Operation Type |
|---|---|
| 0 | Addition |
| 1 | Compare if dot product is high |
| 2 | Compare if dot product is not low |
| 3 | Compare if dot product and element are equal |
| 4 | Compare if dot product and element are not equal |
| 5 | Compare if dot product is not high |
| 6 | Compare if dot product is low |
| 7-255 | Reserved |

In one example, all other values of the OPERATION field are reserved. If a reserved value is specified for the OPERATION field, a response code of, e.g., F000 hex, is reported and the operation completes with a condition code of, e.g., 1. In examples, the OPERATION field is not applicable to the NNPA-MATMUL-OPBCAST23 function when the parameter-block-version number is zero.

Depending on the operation, the value of an input-tensor-3 element is either added to or compared with the intermediate dot product (scaled if applicable), as follows:

In one example, for an operation type of addition, the input tensor 3 element is added to the intermediate dot product. For operation types of comparison, the intermediate dot product is compared to the input tensor 3 element and if the comparison is true, the result is set to a value of, e.g., +1; otherwise, it is set to a value of, e.g., +0, in the data type specified for the output tensor.

Get-Dimension-A-Vector Operation: The get-dimension-A-vector operation returns a vector of elements from input-tensor 1 that is used by the dot-product operation. Processing of the get-dimension-A-vector operation depends on which NNPA-MATMUL function is being performed, as follows:
NNPA-MATMUL-OP: For a specified output element, a dimension-A vector is selected from the input-tensor 1 where the input dimension-4 index is the output dimension-4 index, and the input dimension-3 index is the output dimension-3 index.
NNPA-MATMUL-OP-BCAST23: For a specified output element, a dimension-A vector is selected from input-tensor 1 where the input dimension-4 index is the output dimension-4 index, and the input dimension-3 index is the output dimension-3 index.
NNPA-MATMUL-OP-BCAST1: For a specified output element, a dimension-A vector is selected from input-tensor 1 where the input-dimension-4 index is zero, and the input-dimension-3 index is zero.

When a transposition control, for instance TC1 in bit 31 of function-specific parameter 2, is not applicable, or when TC1 is applicable and zero, the dimension-2 index of input-tensor 1 is the dimension-2 index of output-tensor 1, and dimension 1 of input-tensor 1 includes the resulting dimension-A vector. When TC1 is applicable and one, the dimension-1 index of input-tensor 1 is the dimension-2 index of output-tensor 1, and dimension 2 of input-tensor 1 comprises the resulting dimension-A vector.

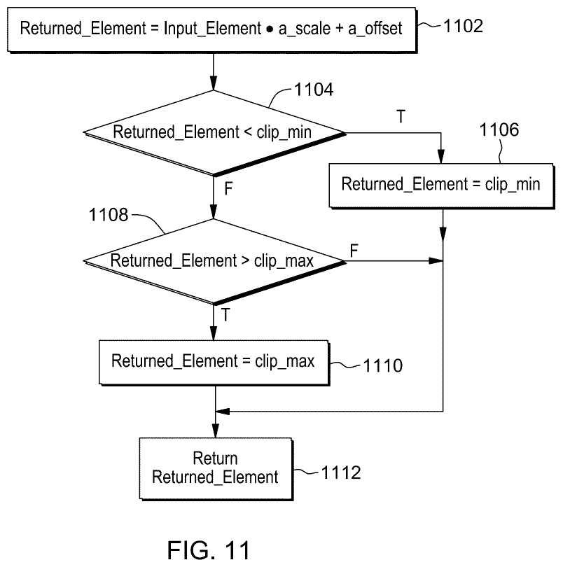

In examples, when the data type of input-tensor 1 is NNP-datatype 1 and the data type of input-tensor 2 is 8-bit signed-binary integer, the elements in the resulting dimension-A vector are further processed by the a_scale, a_offset, clip_min, and clip_max values in, e.g., function-specific parameters 3, 4, 9, and 10, respectively to perform quantization of these elements. FIG. 11 depicts example of this processing. Referring to FIG. 11, the process takes an input element as input. The process sets (1102) Returned_Element=(Input_Element*a_scale)+a_offset. The process then determines (1104) whether Returned_Element<clip_min. If so (1104, T), the process sets (1106) Returned_Element=clip_min and proceeds to 1112 to return Returned_Element. If instead it is determined at 1104 that Returned_Element is not less than clip_min (1104, F), the process determines (1108) whether Returned_Element>clip_max. If so (1108, T), the process sets (1110) Returned_Element=clip_max and proceeds to 1112 to return Returned_Element. If instead it is determined at 1108 that Returned_Element is not greater than clip_max (1108, F), the process proceeds to 1112 to return Returned_Element. Thus, the process of FIG. 11 returns an element as follows: returned_element=MIN(clip_max, MAX(clip_min, input_element*a_scale+a_offset)). The elements in input-tensor 1 may be unchanged.

In examples, if an input element is nonnumeric, or if processing an input element with a_scale and a_offset results in an overflow or underflow, then a range-violation status flag is set and the resulting element value is unpredictable. If the value of a_offset is nonnumeric, a general-operand data exception may be recognized.

Get-Dimension-B-Vector Operation: The get-dimension-B-vector operation returns a vector of elements from input-tensor 2 that is used by the dot-product operation. Processing of the get-dimension-B-vector operation depends on which NNPA-MATMUL function is being performed, as follows:
NNPA-MATMUL-OP: For a specified output element, a dimension-B vector is selected from input-tensor 2 where the input dimension-4 index is the output dimension-4 index, and the input dimension-3 index is the output dimension-3 index.
NNPA-MATMUL-OP-BCAST23: For a specified output element, a dimension-B vector is selected from input-tensor 2 where the input dimension-4 index is zero, and the input dimension-3 index is the output dimension-3 index.

NNPA-MATMUL-OP-BCAST1: For a specified output element, a dimension-B vector is selected from input-tensor 2 where the input dimension-4 index is the output dimension-4 index, and the input dimension-3 index is zero.

When a transposition-control, for instance TC2 in bit 30 of function-specific parameter 2, is not applicable, or when TC2 is applicable and zero, the dimension-1 index of input-tensor 2 is the dimension-1 index of output-tensor 1, and dimension 2 of input-tensor 2 includes the resulting dimension-B vector. When TC2 is applicable and one, the dimension-2 index of input-tensor 2 is the dimension-1 index of output-tensor 1, and dimension 1 of input-tensor 2 comprises the resulting dimension-B vector.

The input-vector dimension that is used to produce the results of the get-dimension-A-vector and get-dimension-B-vector operations is referred to as the ‘common dimension’. The elements from the common dimensions of input-tensors 1 and 2 form the input to the dot-product operation. The a_scale, a_offset, clip_min, and clip_max values (e.g., in function-specific parameters 3, 4, 9, and 10, respectively) that may apply to the get-dimension-A-vector operation may not be applicable to the get-dimension-B-vector operation.

In examples, when the parameter-block-version number is 0, and the specified data-layout-format field in any of the specified tensor descriptors does not contain a value of zero (4D-feature tensor) or if the data-type field in any specified tensor descriptor does not contain a value of zero (NNP-data-type 1), a response code of, e.g., 0010 hex or 0011 hex, respectively, is set in general register 0, and the instruction completes with a condition code, e.g., of 1. In examples, when the parameter-block-version number is 1, and the combination of parameter-block-version number, data-layout formats and data types of each specified tensor descriptor do not match those example valid combinations discussed above, then a response code, e.g., of F001 hex, is set in general register 0, and the instruction completes with a condition code, e.g., of 1.

In examples, all of the following conditions are to be true, otherwise, a general-operand data exception may be recognized:
The dimension-4-index size is to meet the following function-dependent criteria:
NNPA-MATMUL-OP: The dimension-4-index size is to be the same in all input tensors and in output-tensor 1;
NNPA-MATMUL-OP-BCAST23: The dimension-4-index size of input-tensor 1 and output-tensor 1 is to be equal, and the dimension-4-index size of input-tensor 2 and input-tensor 3 are to be equal to one;
NNPA-MATMUL-OP-BCAST1: The dimension-4-index sizes of input-tensor 2, input-tensor 3, and output-tensor 1 are to be the same, and the dimension-4-index size of input-tensor 1 is to be equal to one.
The dimension-3-index size of all input tensors and the output-tensor 1 are to be equal to one;
The dimension-2-index size of the input-tensor 3 is to be equal to one;
Dimension-1-and-2-index sizes of all tensors are to meet the requirements specified in an applicable row of Table 2 below, the applicable row being determined by the applicability of the transposition controls. When PBVN=0, the transposition controls are not applicable and the row in Table 2 corresponding to PBVN=0 applies. When PBVN>0, the rows in Table 2 corresponding to PBVN>0 are meaningful, and, more specifically, one of the rows will apply depending on the values of TC1 and TC2.

TABLE 2

| | Transposition | | Input | | Input | | Input | | Output | |
|---|---|---|---|---|---|---|---|---|---|---|
| | Control | | Tensor 1 | | Tensor 2 | | Tensor 3 | | Tensor 1 | |
| PBVN | TC2 | TC1 | E2 | E1 | E2 | E1 | E2 | E1 | E2 | E1 |
| 0 | — | — | Y | C | C | X | 1 | X | Y | X |
| >0 | 0 | 0 | Y | C | C | X | 1 | X | Y | X |
| | 0 | 1 | C | Y | C | X | 1 | X | Y | X |
| | 1 | 0 | Y | C | X | C | 1 | X | Y | X |
| | 1 | 1 | C | Y | X | C | 1 | X | Y | X |

where the following meanings apply:
-: When transposition controls are not applicable, the row describes the dimension requirements;
C: The common dimension-index size (C) of input-tensors 1 and 2 are to be equal;
En: Dimension-n-index size of the specified input tensor;
TCn: When transposition controls are applicable, a row describes the dimension requirements for the combination of TC2 and TC1;
X: The dimension-index size of input-tensor 2 that is not the common dimension is to be equal to the dimension-1-index sizes of input-tensor 3 and output-tensor 1;
Y: The dimension-index size of input-tensor 1 that is not the common dimension is to be equal to the dimension-2 index size of output-tensor 1; and
1: The dimension-2-index size of input-tensor 3 is to be one.
   When the parameter-block-version number is zero, the data layout and data type of all input tensors and the output-tensor 1 are to be the same;
   When function-specific-parameter, e.g., 4 applies, the value of a_offset is to be a numeric value; and
   When function-specific-parameters, e.g., 9 and 10 apply, the clip_min value is to be less than the clip_max value.

In examples, the output-tensor-descriptor 2, and function-specific-save-area-address fields may be ignored. Function-specific-parameters 11 and above, and function-specific parameters that are not applicable are to contain zeros, otherwise, the program may not operate compatibly. The order of the arithmetic operations may be model dependent and may lead to different results on different models.

In accordance with aspects described herein, quantization can apply to two internal operations of the NNPA-MATMUL functions, as described. One such quantization is part of the Get-Dimension-A-Vector Operation to retrieve a vector from input-tensor 1. In examples, when the data-type of input-tensor 1 is NNP-data-type 1 and the data-type of input-tensor 2 is a selected data type, e.g., INT8 (8-bit signed binary integer), a_scale, a_offset, clip_min, and clip_max are applied to each input element (see FIG. 11). Each element returned may be processed as follows: returned_element=MIN(clip_max, MAX(clip_min, input_element*a_scale+a_offset)). As described, the values used in quantization can be of specific types and stored in specific FSPs, for example as follows: a_scale (NNP data-type 1) in FSP3.16-31, a_offset (NNP data-type 1) in FSP 4.16-31, clip_min (INT8) in FSP 9.24-31, and clip_max (INT8) in FSP 10.24-31. This quantization can ‘trim’ larger elements of an input tensor down to a smaller size to match the format of elements from the other input tensor for the matrix multiplication to be performed.

The other quantization can be performed as part of the Dot-Product Operation to perform matrix multiplication of elements from input-tensors 1 and 2. In examples, when the data type of either of input-tensors 1 or 2 is a selected data type, e.g., INT8, a scaling factor (M) is computed as follows: M=y_scale/(a_scale*b_scale). Each element of the dot-product is multiplied by the scaling factor M. As described, the values used in quantization can be of specific types and stored in specific FSPs, for example as follows: y_scale (NNP data-type 1) in FSP 7.16-31, a_scale (NNP data-type 1) in FSP 3.16-31, b_scale (NNP data-type 1) in FSP 5.16-31.

Accordingly, instruction execution to perform matrix multiplication can perform quantization(s). Additional operations could be performed as part of or separate from instruction execution. A fused operation, for instance, could be performed as part of instruction execution. Scaling and/or other operations could also be performed as part of the instruction execution to form the output, or performed on the output of the instruction execution, if desired.

Accordingly, embodiments of aspects described herein present a computer system that can include a neural network accelerator. The computer system can include/perform a method for decoding and executing a computer instruction that operates on tensors. The computer instruction can provide functions for performing various types of matrix multiplication on two input tensors. The input tensors can have elements in differing data types. The validity of data-layout-formats and data-types can be determined by a parameter-block version number (PBVN). When the data types of the tensors used in the matrix-multiplication function differ, quantization of elements can be performed. For instance, during an operation to get a vector, for instance during a Get-Dimension-A-Vector operation, a scale and offset may be applied, and the result may then be subjected to clipping. Additionally, during matrix multiplication, for instance a Dot-Product operation thereof, scaling may be applied through a combination of, e.g., three scaling factors (a_scale, b_scale, and y_scale).

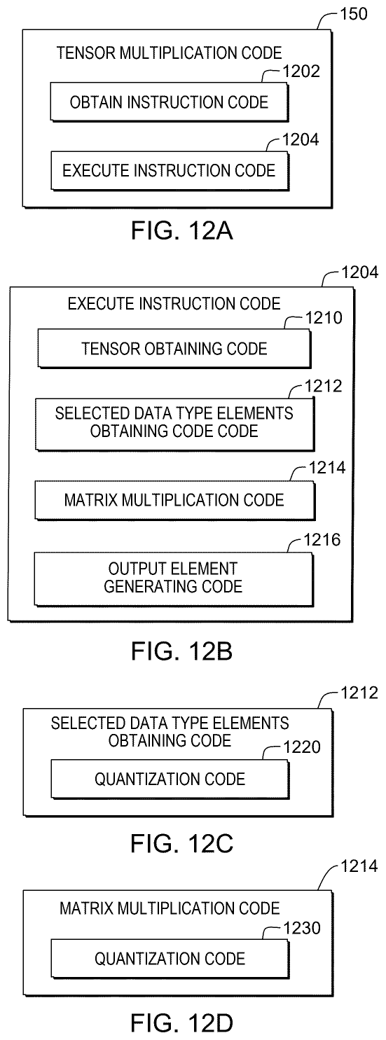

FIG. 12A depicts one example of tensor multiplication code of FIG. 1, in accordance with aspects described herein. In one or more aspects, tensor multiplication code 150 includes, in one example, various sub-modules to be used to perform tensor multiplication. The sub-modules are, e.g., computer-readable program code (e.g., instructions) in computer-readable media, e.g., storage (persistent storage 113, cache 121, storage 124, other storage, as examples). The computer-readable storage media may be part of one or more computer program products and the computer-readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 12A, tensor multiplication code 150 includes obtain instruction code 1202 to obtain (e.g., receive, be provided, pull, retrieve, fetch, etc.) an instruction, such as an instruction to perform tensor multiplication in accordance with aspects described herein, and execute instruction code 1204 to execute the instruction.

Further details of execute instruction code 1204 are described with reference to FIG. 12B. Referring to FIG. 12B, execute instruction code 1204 includes tensor obtaining code 1210 for obtaining a first input tensor and a second input tensor; selected data type elements obtaining code 1212 for obtaining elements of a selected data type based on elements of the first input tensor and elements of the second input tensor; matrix multiplication code 1214 for performing matrix multiplication on the elements of the selected data type, the matrix multiplication including performing quantization of intermediate results, and the quantization scaling the intermediate results to provide scaled results of the matrix multiplication; and output element generating code 1216 for generating output elements, for an output tensor, using the scaled results.

Further details of selected data type elements obtaining code 1212 are described with reference to FIG. 12C. Referring to FIG. 12C, selected data type elements obtaining code 1212 includes quantization code 1220 for performing quantization of the elements of an input tensor having elements of a different data type than the selected data type, in order to provide at least some of the elements of the selected data type for the matrix multiplication. In examples, the quantization of an element of the input tensor includes converting the element of the input tensor using a scale value to scale the element, using an offset value to apply an offset, and using a clip maximum value and a clip minimum value to enforce a maximum value and a minimum value for the element of the selected data type.

Further details of matrix multiplication code 1214 are described with reference to FIG. 12D. Referring to FIG. 12D, matrix multiplication code 1214 includes quantization code 1230 for performing quantization of intermediate results of the matrix multiplication. The quantization scales the intermediate results to provide scaled results of the matrix multiplication. In examples, this quantization includes computing a scaling factor (M) as y_scale/(a_scale*b_scale), and each element of an intermediate dot product is multiplied by the scaling factor M.

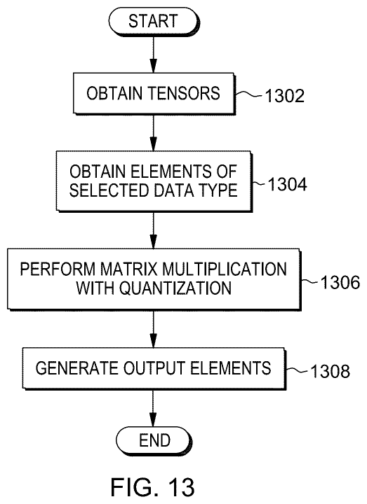

FIG. 13 depicts an example process for tensor multiplication with quantization, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 13 are part of a code module, such as code 150. In other examples, the code may be included in one or more modules and/or in one or more sub-modules of the one or more modules. Various options are available.

The process of FIG. 13 includes obtaining (1302) tensors, for instance a first input tensor and a second input tensor. In examples, the elements of the first input tensor include elements of a first data type, and the elements of the second input tensor include elements of a second data type, the first data type being different than the second data type.

The process continues by obtaining (1304) elements of a selected data type based on elements of the first input tensor and elements of the second input tensor. In examples, the selected data type is of a length that is shorter than a length of the elements of the first input tensor or the elements of the second input tensor.

Obtaining elements of the selected data type might involve quantization of elements of an input tensor. For instance, in examples, elements of an input tensor, of the first input tensor or the second input tensor, are of a different data type than the selected data type, and the executing the instruction further includes performing quantization of the elements of the input tensor to provide at least some of the elements of the selected data type for the matrix multiplication. In examples, quantization of an element of the input tensor includes converting the element of the input tensor using a scale value to scale the element, using an offset value to apply an offset, and using a clip maximum value and a clip minimum value to enforce a maximum value and a minimum value for the element of the selected data type.

In embodiments, executing the instruction further includes checking a value of an indicator (such as a PBVN) and determining, based on the value, that quantization is to be performed, for instance quantization of intermediate results of the matrix multiplication, and optionally quantization of elements of the input tensor as explained above, are to be performed.

In any case, the process continues with performing (1306) matrix multiplication on the elements of the selected data type. The matrix multiplication includes performing quantization of intermediate results, and the quantization scales the intermediate results to provide scaled results of the matrix multiplication. The process continues by generating (1308) output elements, for an output tensor, using the scaled results.

In examples, the generated output elements are provided in another data type, where the another data type is of a length that is greater than the length of the selected data type. For instance, the selected data type might be x-bits long, while the data type of the output elements might be y-bits long where y>x. In specific examples, x is 8 and y is 16, though this is not intended to be limiting.

In some embodiments, a fused operation is performed as part of the matrix multiplication or otherwise to generate the output elements. A fused operation may, for instance, be performed with scaled dot products as intermediate values. A value (determined as the dot product) may be an intermediate value of an element to be provided in an output tensor, and executing the instruction can further include performing an operation using the intermediate value of the element to be provided in the output tensor and an element of a third input tensor to provide a resulting value of the element to be provided in the output tensor.

Thus, in some examples, the generating of the output elements includes performing one or more operations using a third input tensor and the scaled results to obtain the output elements.

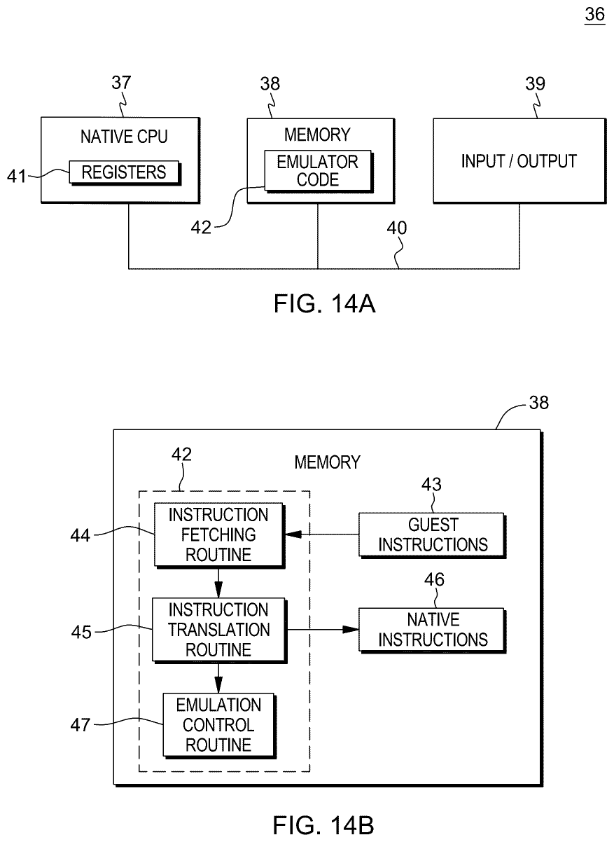

Although one or more examples of a computing environment to incorporate and use one or more aspects of the present disclosure are described herein, FIGS. 14A-14B depict another embodiment of a computing environment to incorporate and use one or more aspects described herein.

Referring, initially, to FIG. 14A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 14B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. One or more aspects of the present disclosure are tied to computer technology and facilitate processing within a computer, improving performance thereof. For instance, processing speed is increased, and latency is reduced by using one instruction, e.g., one architected instruction, to perform tensor multiplication as described herein.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media;
program instructions, collectively stored in the set of one or more computer-readable storage media, for causing at least one computing device to perform computer operations including:
executing an instruction, the executing the instruction including:
obtaining a first input tensor and a second input tensor;
obtaining elements of a selected data type based on elements of the first input tensor and elements of the second input tensor;
performing matrix multiplication on the elements of the selected data type, the matrix multiplication including performing quantization of intermediate results, and the quantization scaling the intermediate results to provide scaled results of the matrix multiplication; and
generating output elements, for an output tensor, using the scaled results.

2. The computer program product of claim 1, wherein the executing the instruction further includes checking a value of an indicator and determining, based on the value, that the quantization is to be performed.

3. The computer program product of claim 1, wherein the elements of the first input tensor include elements of a first data type, and the elements of the second input tensor include elements of a second data type, the first data type being different than the second data type.

4. The computer program product of claim 1, wherein elements of an input tensor, of the first input tensor or the second input tensor, are of a different data type than the selected data type, and wherein the executing the instruction further includes performing quantization of the elements of the input tensor to provide at least some of the elements of the selected data type for the matrix multiplication.

5. The computer program product of claim 4, wherein the quantization of an element of the input tensor includes converting the element of the input tensor using a scale value to scale the element, using an offset value to apply an offset, and using a clip maximum value and a clip minimum value to enforce a maximum value and a minimum value for the element of the selected data type.

6. The computer program product of claim 4, wherein the executing the instruction further includes checking a value of an indicator and determining, based on the value, that the quantization of the intermediate results and the quantization of the elements of the input tensor are to be performed.

7. The computer program product of claim 1, wherein the generating includes performing one or more operations using a third input tensor and the scaled results to obtain the output elements.

8. The computer program product of claim 1, wherein the selected data type is of a length that is shorter than a length of the elements of the first input tensor or the elements of the second input tensor.

9. The computer program product of claim 8, wherein the generated output elements are provided in another data type, the another data type being of a length that is greater than the length of the selected data type.

10. A computer system comprising:
at least one computing device;
a set of one or more computer-readable storage media; and
program instructions, collectively stored in the set of one or more computer-readable storage media, for causing the at least one computing device to perform computer operations including:
executing an instruction, the executing the instruction including:
obtaining a first input tensor and a second input tensor;
obtaining elements of a selected data type based on elements of the first input tensor and elements of the second input tensor;
performing matrix multiplication on the elements of the selected data type, the matrix multiplication including performing quantization of intermediate results, and the quantization scaling the intermediate results to provide scaled results of the matrix multiplication; and
generating output elements, for an output tensor, using the scaled results.

11. The computer system of claim 10, wherein the executing the instruction further includes checking a value of an indicator and determining, based on the value, that the quantization is to be performed.

12. The computer system of claim 10, wherein the elements of the first input tensor include elements of a first data type, and the elements of the second input tensor include elements of a second data type, the first data type being different than the second data type.

13. The computer system of claim 10, wherein elements of an input tensor, of the first input tensor or the second input tensor, are of a different data type than the selected data type, and wherein the wherein the executing the instruction further includes performing quantization of the elements of the input tensor to provide at least some of the elements of the selected data type for the matrix multiplication.

14. The computer system of claim 13, wherein the executing the instruction further includes checking a value of an indicator and determining, based on the value, that the quantization of the intermediate results and the quantization of the elements of the input tensor are to be performed.

15. The computer system of claim 10, wherein the generating includes performing one or more operations using a third input tensor and the scaled results to obtain the output elements.

16. The computer system of claim 10, wherein the selected data type is of a length that is shorter than a length of the elements of the first input tensor or the elements of the second input tensor, and wherein the generated output elements are provided in another data type, the another data type being of a length that is greater than the length of the selected data type.

17. A computer-implemented method comprising:
executing an instruction, the executing the instruction including:
obtaining a first input tensor and a second input tensor;
obtaining elements of a selected data type based on elements of the first input tensor and elements of the second input tensor;
performing matrix multiplication on the elements of the selected data type, the matrix multiplication including performing quantization of intermediate results, and the quantization scaling the intermediate results to provide scaled results of the matrix multiplication; and
generating output elements, for an output tensor, using the scaled results.

18. The method of claim 17, wherein the executing the instruction further includes checking a value of an indicator and determining, based on the value, that the quantization is to be performed.

19. The method of claim 17, wherein the elements of the first input tensor include elements of a first data type, and the elements of the second input tensor include elements of a second data type, the first data type being different than the second data type.

20. The method of claim 17, wherein elements of an input tensor, of the first input tensor or the second input tensor, are of a different data type than the selected data type, and wherein the wherein the executing the instruction further includes performing quantization of the elements of the input tensor to provide at least some of the elements of the selected data type for the matrix multiplication.

21. The method of claim 20, wherein the executing the instruction further includes checking a value of an indicator and determining, based on the value, that the quantization of the intermediate results and the quantization of the elements of the input tensor are to be performed.

22. The method of claim 17, wherein the generating includes performing one or more operations using a third input tensor and the scaled results to obtain the output elements.

23. The method of claim 17, wherein the selected data type is of a length that is shorter than a length of the elements of the first input tensor or the elements of the second input tensor, and wherein the generated output elements are provided in another data type, the another data type being of a length that is greater than the length of the selected data type.

24. A computer system comprising:
at least one hardware accelerator to be used in executing an instruction, the executing the instruction including:
obtaining a first input tensor and a second input tensor;
checking a value of an indicator and determining, based on the value, that quantization is to be performed;
obtaining elements of a selected data type based on elements of the first input tensor and elements of the second input tensor, wherein the selected data type is of a length that is shorter than a length of the elements of the first input tensor or the elements of the second input tensor;
performing matrix multiplication on the elements of the selected data type, the matrix multiplication including performing quantization of intermediate results, and the quantization scaling the intermediate results to provide scaled results of the matrix multiplication; and
generating output elements, for an output tensor, using the scaled results, wherein the generated output elements are provided in another data type, the another data type being of a length that is greater than the length of the selected data type.

25. A computer-implemented method comprising:
executing an instruction, the executing the instruction including:
obtaining a first input tensor and a second input tensor;
checking a value of an indicator and determining, based on the value, that quantization is to be performed;
obtaining elements of a selected data type based on elements of the first input tensor and elements of the second input tensor, wherein the selected data type is of a length that is shorter than a length of the elements of the first input tensor or the elements of the second input tensor;
performing matrix multiplication on the elements of the selected data type, the matrix multiplication including performing quantization of intermediate results, and the quantization scaling the intermediate results to provide scaled results of the matrix multiplication; and
generating output elements, for an output tensor, using the scaled results, wherein the generated output elements are provided in another data type, the another data type being of a length that is greater than the length of the selected data type.
